(19) United States
(12) Patent Application Publication
(10) Pub. No.: US 2005/0142495 A1
(43) Pub. Date: Jun. 30, 2005

(54) Methods of controlling multilayer foil ignition

(76) Inventors: David Peter Van Heerden, Baltimore, MD (US); Etienne Besnoin, Brooklyn, NY (US); Stephen John Spey JR., Baltimore, MD (US); Timothy Ryan Rude, Timonium, MD (US); Michael V. Brown, Timonium, MD (US); Dale Deger, Littlestown, PA (US); Ellen Heian, Cockeysville, MD (US); Somasundaram Valliappan, Cockeysville, MD (US); Omar M. Knio, Timonium, MD (US); Timothy P. Weihs, Baltimore, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/959,502

(22) Filed: Oct. 7, 2004

Related U.S. Application Data
(60) Provisional application No. 60/509,526, filed on Oct. 9, 2003.

(51) Int. Cl. G03C 3/00

(52) U.S. Cl. 430/311

(57) ABSTRACT

Embodiments of the invention include a method of simulating an ignition of a reactive multilayer foil. Other embodiments include various methods of igniting a reactive multilayer foil by transferring energy from an energy source to a reactive multilayer foil.

### CROSS-REFERENCE TO RELATED APPLICATION

This application claims the benefits of priority under 35 U.S.C. §119(e) to U.S. Provisional Patent Application No. 60/509,526, filed Oct. 9, 2003, the entirety of which is incorporated herein by reference.

### STATEMENT REGARDING FEDERALLY SPONSORED RESEARCH

This invention was made with U.S. Government support under National Science Foundation Award Nos. DMI-0115238, DMI-0232398, and National Institute of Standards and Technology Award No. 70NANB3H3045. The U.S. Government has certain rights in this invention.

### DESCRIPTION OF THE INVENTION

1. Field of the Invention

Embodiments of the invention include a method of simulating an ignition of a reactive multilayer foil. Other embodiments include various methods of igniting a reactive multilayer foil by transferring energy from an energy source to a reactive multilayer foil.

2. Background of the Invention

Reactive multilayer foils are nanostructured materials typically fabricated by vapor depositing hundreds of nanoscale layers that alternate between elements with large, negative heats of mixing such as Ni and Al. These ignitable materials support self-propagating reactions (e.g., chemical transformations) that travel along the foils at speeds ranging from about 1 m/s to about 30 m/s. Various implementations of these materials and related methods are disclosed in the following, the entirety of all of which are incorporated herein by reference: U.S. Pat. Nos. 5,381,944, 5,538,795, 5,547,715, and 6,534,194; U.S. patent application Ser. No. 09/846,486 filed May 1, 2001 and entitled “Free Standing Reactive Multilayer Foils” (“the '486 application); U.S. Provisional Patent Application No. 60/201,292 filed on May 2, 2000 and entitled “Free Standing Reactive Multilayer Foils” (“the '292 application”); an article by Besnoin et al. entitled “Effect of Reactant and Product Melting on Self-Propagating Reactions in Multilayer Foils” published in the Journal of Applied Physics, Vol. 92(9), pages 5474-5481 on Nov. 1, 2002 (“Besnoin”); an article by Blobaum et al. entitled “Deposition and Characterization of a Self-Propagating CuOx/Al Thermite Reaction in a Multilayer Foil Geometry” published in the Journal of Applied Physics, Vol. 94(5), pages 2915-2922 on Sep. 1, 2003; a chapter entitled “Self-Propagating Reactions in Multilayer Materials” published in the 1998 edition of the Handbook of Thin Film Process Technology edited by D. A. Glocker and S. I. Shah (“Glocker”); and an article entitled “Self-Propagating Exothermic Reactions in Nanoscale Multilayer Materials” that was presented at The Minerals, Metals, and Materials Society (TMS) Proceeding on Nanostructures in February of 1997 (“TMS”).

Self-propagating reactions (e.g., chemical transformations) in reactive multilayer foils are driven by a reduction in chemical bond energy, examples of which are disclosed in Glocker and an article by Gavens et al. entitled “Effects of Intermixing on Self-Propagating Exothermic Reactions in Al/Ni Nanolaminate Nanofoils” published in the Journal of Applied Physics, Vol. 87(3), pages 1255-1263 on Feb. 1, 2000 (“Gavens”), the entirety of both of which are incorporated herein by reference. Upon the application of a suitable stimulus (e.g., ignition or initiation of the chemical transformation), a local bond exchange between constituents of alternating layers produces large quantities of heat that are conducted down the foil and sustain the reaction. Recent developments in reactive multilayer foil technology have shown that it is possible to carefully control both the heat of the reaction as well as the reaction velocity, and have also provided alternative means for fabricating nanostructured multilayer foils. For instance, it has been demonstrated that the velocities, heats, and/or temperatures of the reactions can be controlled by varying the thicknesses of the alternating layers, as shown in U.S. Pat. No. 5,538,795; an article entitled “The Combustion Synthesis of Multilayer NiAl Systems” published in Scripta Metallurgica et Materialia, Vol. 30(10), pages 1281-1286 in 1994; Gavens; the '486 application; and the '292 application, the entirety of each of which are incorporated herein by reference. It has also been shown that the heats of reaction can be controlled by modifying the foil composition, or by low-temperature annealing of the reactive multilayers after their fabrication, for example, as shown in Gavens. Alternative methods for fabricating nanostructured reactive multilayers include: (i) mechanical processing, which is described in detail by U.S. Pat. No. 6,534,194, and (ii) electrochemical deposition.

These technological advancements set forth above—including the control of reaction heats, velocities, and temperatures, as well as alternative multilayer foil fabrication methods—have widened the scope of potential applications of reactive multilayer foils to include: (a) reactive multilayer joining (examples of which are disclosed in U.S. Provisional Patent Application No. 60/469,841 filed May 13, 2003 (“the 841 application) and U.S. patent application Ser. No.10/843,352 filed May 12, 2004 (“the 352 application), the entirety of both of which are incorporated herein by reference), (b) hermetic sealing (examples of which are disclosed in U.S. Provisional Patent Application No. 60/461,196 filed Apr. 9, 2003 and U.S. patent application Ser. No. 10/814,243 filed Apr. 1, 2004, the entirety of both of which are incorporated herein by reference), (c) structural energetics, and (d) the use of reactive multilayer foils for initiating secondary reactions, e.g. in fuses and detonators.

Several different means have been employed for igniting self-propagating reactions (e.g., initiating the chemical transformation) in nanoscale multilayer foils. In some methods, impact of a sharp stylus initiates ignition, and in other ignition is started with a spark from an electrical source (examples of which are disclosed in an article by Ma et al. entitled “Self-propagating Explosive Reactions in Al/Ni Multilayer Thin Films” published in Applied Physics Letters, Volume 57, page 1262 in 1990 (“Ma”); an article by Reiss et al. entitled “Self-propagating Formation Reactions in Nb/Si Multilayers” published in Mat. Sci. and Eng. A., Volume A261, pages 217-222 in 1999; an article by van Heerden et al. entitled “Metastable Phase Formation and Microstructural Evolution during Self-Propagating Reactions in Al/Ni and Al/Monel Multilayers” published in Mat. Res. Soc. Symp. Proceedings, Volume 481, pages 533-8 in the Fall of 1997; and TMS, the entirety of all of which are incorporated herein by reference). Alternatively, the heat from a filament (examples of which are disclosed in an article by Anselmi-Tamburni et al. entltied “The Propagation of a Solid-State Combustion Wave in Ni-Al Foils” published in the Journal of Applied Physics, Volume 66, page 5039 in 1989; and an article by Dyer et al. entitled “The Combustion Synthesis of Multilayer NiAl Systems” published in Scripta Metallurgica et Materialia, Volume 30, page 1281 in 1994, the entirety of both of which are incorporated herein by reference), or laser radiation (examples of which are disclosed in an article by Wickersham et al. entitled “Explosive Crystallization in Zirconium/Silicon Multilayers” published in the J. Vac. Sci. Technol. A, Volume 6, page 1699 in 1988 (“Wickersham”), the entirety of which is incorporated herein by reference) may be used to start ignition. To begin to understand what power or energy is needed to ignite a reaction, Ma investigated the effect of the period of a multilayer foil has on the reaction process using Ni/Al multilayer foils and an electrical stimulus. Results disclosed in Ma suggest that reactions in films with larger periods require more power for ignition than reactions in films with smaller periods. The results also suggest that power requirements decrease as the initial sample temperature increases. Wickersham conducted an ignition study on Zr/Si multilayer films using the impact from a tungsten-carbide (WC) tip to start the reaction. According to Wickersham, thicker films were ignited at lower sample temperatures for a given period of a multilayer foil. These two studies suggest that ignition depends on bilayer thickness (e.g., period), initial sample temperature, and overall foil thickness.

Prior knowledge regarding ignition of reactive multilayer foils is, however, limited, in large part because several essential factors controlling ignition requirements have not been clearly investigated and the extent of their impact is consequently unknown, although some material is disclosed, for example, in U.S. Pat. No. 5,606,146. These include such features as intermixing between layers (examples of which are disclosed in Gavens and Glocker), the duration of the stimulus, and the energy or power density of the ignition source. This lack of knowledge regarding key properties of the ignition source constitutes an obstacle to the design of effective ignition systems and devices.

Another limitation arises in situations where direct access to the foil is not available when the reaction must be initiated. A case-in-point concerns bonding or joining applications where the reactive foil is sandwiched between two solder or braze layers (e.g., lead, tin, silver, zinc, gold, and/or antimony) and two components (examples of which are disclosed in U.S. Pat. No. 5,381,944, the '841 application, and the '352 application). In many cases, (e.g., the mounting of heat sinks onto chips or chip packages or bonding of microelectronic components) a direct-access method of ignition may not be practical because the foil is “shielded” by the components. Thus, in these situations methods of ignition are needed that effectively address this problem.

In order to overcome the limitations above, aspects of the invention introduces a new methodology for the ignition of reactive multilayer foils. Some of these aspects of the present invention include:

Application of a multi-dimensional computational code for the determination of energy requirements of ignition sources. The code may be based on a multi-dimensional transient formulation of the evolution equations of energy and composition;

Methods for the ignition of reactive multilayer foils; and

Methods for overcoming accessibility limitations.

These and other aspects of the invention are described in detail in various exemplary embodiments set forth herein.

### SUMMARY OF THE INVENTION

An embodiment of the invention includes a method for simulating an initiation and properties of a self-propagating reaction in a reactive multilayer foil. The method includes providing an atomic concentration evolution equation, providing an energy evolution equation including energy source terms associated with (i) a thermal diffusion of the reactive multilayer foil, (ii) a heat of mixing of the reactive multilayer foil, and (iii) a stimulus configured to initiate a chemical transformation of the reactive multilayer foil, discretizing the atomic concentration evolution equation and the energy evolution equation to form a discretized system of equations, and determining the behavior of an atomic concentration and energy fields of the reactive multilayer foil by integrating the discretized system of equations using parameters associated with the reactive multilayer foil.

Another embodiment of the invention includes a program storage device readable by a machine, tangibly embodying a program of instructions executable by the machine to perform method steps for simulating an initiation and properties of a self-propagating reaction in a reactive multilayer foil. The method includes the steps of providing an atomic concentration evolution equation, providing an energy evolution equation including energy source terms associated with (i) a thermal diffusion of the reactive multilayer foil, (ii) a heat of mixing of the reactive multilayer foil, and (iii) a stimulus configured to initiate a chemical transformation of the reactive multilayer foil, discretizing the atomic concentration evolution equation and the energy evolution equation to form a discretized system of equations, and determining the behavior of an atomic concentration and energy fields of the reactive multilayer foil by integrating the discretized system of equations using parameters associated with the reactive multilayer foil.

In various embodiments, the invention may include one or more of the following aspects: the atomic concentration evolution equation may be

$$\frac{ⅆ C}{ⅆ t} - ∇ \cdot ( D ∇ C ) = 0$$

wherein C is atomic concentration and D is atomic diffusivity of the reactive multilayer foil; the energy evolution equation may be

$$\frac{ⅆ H}{ⅆ t} = ∇ \cdot ( k ∇ T ) + \frac{ⅆ Q}{ⅆ t}$$

wherein H is enthalpy, k is thermal conductivity, t is time, T is temperature, and Q is heat of reaction of the reactive multilayer foil; the energy evolution equation may be

$$\frac{ⅆ H}{ⅆ t} = ∇ \cdot ( k ∇ T ) + \frac{ⅆ Q}{ⅆ t} + {q}^{m}$$

wherein H is enthalpy, k is thermal conductivity, t is time, T is temperature, and Q is heat of reaction of the reactive multilayer foil, wherein q^{m} is rate of energy generation associated with the stimulus; the discretization of the atomic concentration evolution equation and the energy evolution equation may be based on a finite-difference method, a finite-element method, a finite-volume method, a spectral-element method, or a collocation method; the parameters associated with the reactive multilayer foil may include at least one of length, width, thickness, density, heat capacity, thermal conductivity, heat of fusion, melting temperature, heat of reaction, atomic weight, atomic diffusivity, and activation energy; the stimulus may be associated with one or more of an electrical source, a thermal source, a source of mechanical action, a sound source, an ultrasound source, a microwave source, a chemical source, an RF source, and an electromagnetic source; the energy source term associated with the stimulus may be a volumetric source term, a surface source term, or a combination of the volumetric and surface source terms; varying parameters of the stimulus; and the parameters associated with the stimulus may include one or more of a position of the stimulus relative to the reactive multilayer foil, potential energy, kinetic energy, electrical potential, current voltage, pulse duration, contact area, power, wavelength, spot size, and pulse energy.

A further embodiment of the invention includes a method of initiating a chemical transformation of a reactive multilayer foil. The method includes providing an electrical energy source and the reactive multilayer foil, and initiating the chemical transformation of the reactive multilayer foil by providing an arc-free discharge from the electrical energy source to the reactive multilayer foil.

In various embodiments, the invention may include one or more of the following aspects: the electrical energy source may include one or more of a voltage source, a current source, a charged capacitor, a piezoelectric device, a thermoelectric device, and a ferroelectric device; the electrical energy source may have a potential less than or equal to about 10 V; the electrical energy source may have a potential less than or equal to about 5V; the electrical energy source may have a potential less than or equal to about 1V; the arc-free discharge may have a duration less than or equal to about 1 ms, an electrical lead may be operatively connected to the electrical energy source and placed in contact with the reactive multilayer material; a contact area between the electrical lead and the reactive multilayer foil may have a diameter less than or equal to about 1 mm; the arc-free discharge may be provided to the reactive multilayer material at a contact area less than or equal to about 1 mm; and the arc-free discharge may have an energy less than or equal to about 40 mJ.

Still another embodiment of the invention includes a method of initiating a chemical transformation of a reactive multilayer foil. The method includes providing a laser source and the reactive multilayer foil, and initiating the chemical transformation of the reactive multilayer foil by transferring energy from the laser source to the reactive multilayer material. The energy from the laser source impinges on a spot on the reactive multilayer foil having an area less than or equal to about 1 mm.

A still further embodiment of the invention includes a method of initiating a chemical transformation of a reactive multilayer foil. The method includes providing a laser source and the reactive multilayer foil, and initiating the chemical transformation of the reactive multilayer foil by transferring energy from the laser source to the reactive multilayer material. The laser source has a power output less than or equal to about 300 W.

Yet another embodiment of the invention includes a method of initiating a chemical transformation of a reactive multilayer foil. The method includes providing a laser source and the reactive multilayer foil, and initiating the chemical transformation of the reactive multilayer foil by transferring energy from the laser source to the reactive multilayer material. The energy transferred is less than or equal to about 40 mJ.

A yet further embodiment of the invention includes a method of initiating a chemical transformation of a reactive multilayer foil. The method includes providing a laser source and the reactive multilayer foil, and initiating the chemical transformation of the reactive multilayer foil by transferring energy from the laser source to the reactive multilayer material. The energy is transferred at a wavelength between about 300 nm and about 2 microns.

Another embodiment of the invention includes a method of initiating a chemical transformation of a reactive multilayer foil. The method includes providing a laser source and the reactive multilayer foil, and initiating the chemical transformation of the reactive multilayer foil by transferring energy from the laser source to the reactive multilayer material. The reactive multilayer foil includes at least one layer of solder or braze.

In various embodiments, the at least one layer of solder or braze may include one or more of indium, lead, tin, silver, zinc, gold, and antimony.

A further embodiment of the invention includes a method of initiating a chemical transformation of a reactive multilayer foil. The method includes providing a laser source and the reactive multilayer foil, providing a component to be joined to another component by the chemical transformation of the reactive multilayer foil, the component including an optical path configured to allow the energy from the laser source to be transferred to the reactive multilayer foil via the optical path, and initiating the chemical transformation of the reactive multilayer foil by transferring energy from the laser source to the reactive multilayer foil through the optical path.

Still another embodiment of the invention includes a method of initiating a chemical transformation of a reactive multilayer foil. The method includes providing a laser source and the reactive multilayer foil, and initiating the chemical transformation of the reactive multilayer foil by transferring energy from the laser source to the reactive multilayer material. The energy from the laser source is redirected prior to being transferred to the reactive multilayer foil.

In various embodiments, the invention may include providing an optical system and redirecting the energy via the optical system.

A still further embodiment of the invention includes a method of initiating a chemical transformation of a reactive multilayer foil. The method includes providing a laser source, a fiber optic cable, and the reactive multilayer foil, and initiating the chemical transformation of the reactive multilayer foil by transferring energy from the laser source via the fiber optic cable to the reactive multilayer material. [030] Yet another embodiment of the invention includes a method of initiating a chemical transformation of a reactive multilayer foil. The method includes providing a laser source and the reactive multilayer foil, the reactive multilayer foil being partially coated with an energy absorbing material, and initiating the chemical transformation of the reactive multilayer foil by transferring energy from the laser source to the energy absorbing material.

In various embodiments, the invention may include one or more of the following aspects: the reactive multilayer foil may be partially coated with an energy reflecting material; the energy reflecting material may have a higher reflectivity than the reactive multilayer foil; the energy absorbing material may include carbon black or black ink; and the energy absorbing material may have a higher absorptivity than the reactive multilayer foil.

A yet further embodiment of the invention may include a method of initiating a chemical transformation of a reactive multilayer foil. The method includes providing a microwave source and the reactive multilayer foil, and initiating the chemical transformation of the reactive multilayer foil by transferring energy from the microwave source to the reactive multilayer foil.

Another embodiment of the invention includes a method of initiating a chemical transformation of a reactive multilayer foil. The method includes providing the reactive multilayer foil and a projectile, and penetrating the reactive multilayer foil with the projectile. The penetrating initiates the chemical transformation of the reactive multilayer material.

In various embodiments, the projectile may be spring-loaded.

A further embodiment of the invention includes a method of initiating a chemical transformation of a reactive multilayer foil. The method includes providing an ultrasound source and the reactive multilayer foil, and initiating the chemical transformation of the reactive multilayer foil by transferring energy from the ultrasound source to the reactive multilayer foil.

Still another embodiment of the invention includes a method of initiating a chemical transformation of a reactive multilayer foil. The method includes providing an induction heating source and the reactive multilayer foil, and initiating the chemical transformation of the reactive multilayer foil by transferring energy from the induction heating source to the reactive multilayer foil.

In various embodiments, the invention may include one or more of the following aspects: the reactive multilayer foil may include a magnetic element; the magnetic element may be Ni.

A still further embodiment of the invention includes a method of initiating a chemical transformation of a reactive multilayer foil. The method includes providing the reactive multilayer foil, and initiating the chemical transformation of the reactive multilayer foil by mechanically fracturing the reactive multilayer foil.

In various embodiments, the invention may include one or more of the following aspects: the reactive multilayer foil may include a recessed portion; the recessed portion may be configured to assist in the mechanical fracturing of the reactive multilayer foil; and the reactive multilayer foil may be configured to mechanically fracture at the recessed portion.

Yet another embodiment of the invention includes a method of initiating a chemical transformation of a reactive multilayer foil. The method includes providing the reactive multilayer foil, and initiating the chemical transformation of a reactive multilayer foil by generating friction on the reactive multilayer foil.

In various embodiments, the invention may include one or more of the following aspects: providing an object with an abrasive surface; generating friction may include placing the abrasive surface in contact with the reactive multilayer foil; generating friction may include rotating the object; generating friction may include sliding the object; the object may include a rotary tool bit; the object may include a diamond wheel.

A yet further embodiment of the invention includes a method of initiating a chemical transformation of a reactive multilayer foil. The method includes providing an electrical energy source, the reactive multilayer foil, and an electrical lead, and initiating the chemical transformation of the reactive multilayer foil by transferring energy from the electrical energy source to the reactive multilayer foil via the electrical lead.

In various embodiments, the invention may include one or more of the following aspects: providing a component to be joined to another component by the chemical transformation of the reactive multilayer foil; the component may include the electrical lead; the electrical energy source may include one or more of a voltage source, a current source, a charged capacitor, a piezoelectric device, a thermoelectric device, and a ferroelectric device.

Another embodiment of the invention includes a method of initiating a chemical transformation of a reactive multilayer material. The method includes providing the reactive multilayer material and a component including an ignition source, and initiating the chemical transformation of the reactive multilayer material by triggering the ignition source.

In various embodiments, the invention may include one or more of the following aspects: triggering the ignition source may include remotely triggering the ignition source; the ignition source may include one or more of a voltage source, a current source, a charged capacitor, a piezoelectric device, a thermoelectric device, a ferroelectric device, a firing pin, a laser, a MEMS device, a hot filament, a solenoid, a gated switch, an abrasive surface, a microbubble, a fuse, a reactive multilayer tab, a chemical, an SHS powder, and a heated gas.

A further embodiment of the invention includes a method of initiating a chemical transformation of a reactive multilayer foil. The method includes providing a chemical and the reactive multilayer foil, and initiating a chemical transformation of a reactive multilayer foil by chemically transforming the chemical.

Still another embodiment of the invention includes a method of initiating a chemical transformation of a reactive multilayer foil. The method includes providing the reactive multilayer foil, and heating the reactive multilayer foil to the foil's ignition temperature.

In various embodiments, the invention may include one or more of the following aspects: providing a heating source; placing the reactive multilayer foil in the source of heat; the heating may include heating the reactive multilayer foil in the heating source; the heating source may be a furnace, reflow oven, heat spreader, or heat sink; the heating may occur at a rate greater than or equal to about 200° C./min; the heating may include heating one side of the reactive multilayer foil; the reactive multilayer foil may be disposed in an enclosure (or assembly); the heating may include heating one side of the enclosure (or assembly); the reactive multilayer foil may be disposed between two or more components configured to be joined by the chemical transformation of the reactive multilayer foil; the heating may include heating one of the two or more components; and the heating of one of the two or more components may include passing a current through the one of the two or more components.

A still further embodiment of the invention includes a method of initiating a chemical transformation of a reactive multilayer foil. The method includes providing the reactive multilayer foil and a molten material, and initiating the chemical transformation of the reactive multilayer foil by transferring energy from the molten material to the reactive multilayer foil.

In various embodiments, the invention may include one or more of the following aspects: placing the molten material in contact with the reactive multilayer foil; and the molten material may be molten solder or molten braze.

Yet another embodiment of the invention includes a method of initiating a chemical transformation of a reactive multilayer foil. The method includes providing the reactive multilayer foil and a microflame; and initiating the chemical transformation of the reactive multilayer foil by transferring energy from the microflame to the reactive multilayer foil.

In various embodiments, the invention may include one or more of the following aspects: placing the microflame in contact with the reactive multilayer foil; the reactive multilayer foil may be disposed between at least two components; a portion of the reactive multilayer foil may extend past an edge of at least one of the at least two components; and directing the microflame towards the portion of the reactive multilayer foil.

A yet further embodiment of the invention includes a method of initiating a chemical transformation of a reactive multilayer foil. The method includes providing the reactive multilayer foil, the reactive multilayer foil being surrounded by an enclosure or disposed within an assembly, providing an energy source, and initiating the chemical transformation of the reactive multilayer foil by transferring energy from the energy source to the reactive multilayer foil.

In various embodiments, the invention may include one or more of the following aspects: the energy may be transferred without penetrating the enclosure or assembly; the energy may be transferred to the reactive multilayer foil when the energy source is disposed outside of the enclosure or assembly; the energy may be transferred without placing the source of energy in physical contact with the reactive multilayer foil; the enclosure or assembly may be substantially airtight; the energy source may include one or more of a microwave source, an ultrasound source, and a source of induction heating.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1(a) depicts exemplary predicted ignition thresholds according to an embodiment of the invention;

FIG. 1(b) depicts exemplary predicted ignition thresholds according to another embodiment of the invention;

FIG. 2(a) depicts exemplary predicted ignition thresholds according to a further embodiment of the invention;

FIG. 2(b) depicts exemplary predicted ignition thresholds according to yet another embodiment of the invention;

FIG. 3(a) depicts exemplary predicted ignition thresholds according to a yet further embodiment of the invention;

FIG. 3(b) depicts exemplary predicted ignition thresholds according to still another embodiment of the invention;

FIG. 4 depicts a schematic view of an ignition configuration according to a still further embodiment of the invention;

FIG. 5 depicts a power density distribution associated with the configuration of FIG. 4;

FIG. 6 depicts exemplary predicted ignition thresholds according to another embodiment of the invention;

FIG. 7 depicts exemplary predicted ignition thresholds according to a further embodiment of the invention;

FIG. 8 depicts exemplary predicted ignition thresholds according to yet another embodiment of the invention;

FIG. 9 depicts exemplary predicted ignition thresholds and an experimental measurement according to a yet further embodiment of the invention;

FIG. 10 depicts exemplary predicted ignition thresholds and an experimental measurement according to still another embodiment of the invention;

FIG. 11 depicts exemplary predicted ignition thresholds according to a still further embodiment of the invention;

FIG. 12 depicts exemplary ignition thresholds according to another embodiment of the invention;

FIG. 13 depicts exemplary measurements of ignition thresholds according to a further embodiment of the invention;

FIG. 14(a) depicts a schematic view of an ignition configuration according to yet another embodiment of the invention;

FIG. 14(b) depicts a schematic view of the ignition configured to FIG. 14(a);

FIG. 15(a) depicts a schematic view of an ignition configuration according to a yet further embodiment of the invention;

FIG. 15(b) depicts a schematic view of the ignition configured to FIG. 14(a);

FIG. 16 depicts exemplary measurements of ignition thresholds according to still another embodiment of the invention;

FIG. 17 depicts exemplary measurements of ignition thresholds according to a still further embodiment of the invention;

FIG. 18 depicts exemplary measurements of ignition thresholds according to another embodiment of the invention;

FIG. 19 depicts a schematic view of an ignition configuration according to a further embodiment of the invention;

FIG. 20 depicts a schematic view of an ignition configuration according to still another embodiment of the invention;

FIG. 21 depicts a schematic view of an ignition configuration according to a still further embodiment of the invention;

FIG. 22 depicts a schematic view of an ignition configuration according to yet another embodiment of the invention;

FIG. 23 depicts a schematic view of an ignition configuration according to a yet further embodiment of the invention;

FIG. 24 depicts a schematic view of an ignition configuration according to another embodiment of the invention;

FIG. 25 depicts a schematic view of an ignition configuration according to a further embodiment of the invention;

FIG. 26 depicts a schematic view of an ignition configuration according to still another embodiment of the invention;

FIG. 27 depicts a schematic view of an ignition configuration according to a still further embodiment of the invention;

FIG. 28 depicts a schematic view of an ignition configuration according to yet another embodiment of the invention;

FIG. 29 depicts exemplary measurements of ignition thresholds according to a yet further embodiment of the invention;

FIG. 30 depicts exemplary measurements of ignition thresholds according to another embodiment of the invention;

FIG. 31 depicts a schematic view of an ignition configuration according to a further embodiment of the invention;

FIG. 32 depicts a schematic view of an ignition configuration according to yet another embodiment of the invention;

FIG. 33 depicts a schematic view of an ignition configuration according to a yet further embodiment of the invention;

FIG. 34 depicts a schematic view of an ignition configuration according to still another embodiment of the invention;

FIG. 35(a) depicts a schematic view of an ignition configuration according to a still further embodiment of the invention;

FIG. 35(b) depicts a schematic view of the ignition configuration of FIG. 35(a);

FIG. 36(a) depicts a schematic view of an ignition configuration according to another embodiment of the invention;

FIG. 36(b) depicts a perspective view of an ignition configuration according to a further embodiment of the invention;

FIG. 36(c) depicts a perspective view of an ignition configuration according to still another embodiment of the invention; and

FIG. 37 depicts a schematic view of an ignition configuration according to a still further embodiment of the invention;

FIG. 38(a) depicts a schematic view of an ignition configuration according to yet another embodiment of the invention;

FIG. 38(b) depicts a schematic view of an ignition configuration according to a yet further embodiment of the invention;

FIG. 38(c) depicts a schematic view of an ignition configuration according to another embodiment of the invention;

FIG. 39(a) depicts a schematic view of an ignition configuration according to a further embodiment of the invention;

FIG. 39(b) depicts a schematic view of an ignition configuration according to still another embodiment of the invention;

FIG. 40 depicts a schematic view of an ignition configuration according to a still further embodiment of the invention;

FIG. 41 depicts a schematic view of an ignition configuration according to a yet another embodiment of the invention;

### DESCRIPTION OF THE EMBODIMENTS

Reference will now be made in detail to exemplary embodiments of the invention which are set forth in the accompanying drawings and specification. Wherever possible, the same reference numbers will be used throughout the drawings to refer to the same or like parts.

In one embodiment of this invention, the energy and power requirements of an energy source (e.g., ignition source) may be determined via systematic application of a transient multi-dimensional model of self-propagating reaction (e.g., chemical transformation) for a reactive multilayer material (e.g., foil). As outlined in Besnoin, self-propagating reactions may be described using a simplified model for atomic mixing and heat release.

Implementation of the model may be illustrated for nanostructured Ni/Al foils with a 1:1 ratio of the reactants. For these foils, atomic mixing can be described using a time-dependent, conserved scalar (atomic concentration) field C, defined such that C=1 for pure Al, C=−1 for pure Ni, and C=0 for pure NiAl. The evolution of C is governed by:

$$\frac{ⅆ C}{ⅆ t} - ∇ \cdot ( D ∇ C ) = 0$$

The atomic diffusivity, D, may be assumed to be independent of composition and to follow an Arrhenius dependence on temperature, according to:

$$D = {D}_{o} exp ( - \frac{E}{R T} )$$

where D₀ is the Arrhenius pre-exponent, E is the activation energy and R is the universal gas constant. The values E=137 kJ/mol and D₀=2.18×10⁻⁶ m²/s used in the embodiments below may be obtained from best fits to experimental data, as shown, for example, in an article by Mann et al. entitled “Predicting the Characteristics of Self-Propagating Exothermic Reactions in Multilayer Foils” published in the Journal of Applied Physics, Volume 82, pages 1178-1188 in 1997, the entirety of which is incorporated herein by reference. In performing computations using any or all of the formulas set forth herein, advantage may be taken of the fact that the layers are geometrically flat, and exploit the symmetry of the periodic arrangement of the layers by restricting the domain to one half of a representative Al layer, as shown, for example, in the '841 application and the '352 application.

The evolution of the concentration field may be coupled with the section-averaged energy equation:

$$\frac{ⅆ H}{ⅆ t} = ∇ \cdot ( k ∇ T ) + \frac{ⅆ Q}{ⅆ t}$$

where H is the section-averaged enthalpy,

$$\overline{k} ≡ \frac{{k}^{Al} + γ {k}^{Ni}}{1 + γ}$$

is the mean thermal conductivity, k^{Al} and k^{Ni} are the thermal conductivities of Al and Ni, respectively,

$$γ ≡ \frac{{ρ}^{Al}}{{ρ}^{Ni}} \frac{{M}^{Ni}}{{M}^{Al}}$$

ρ^{Al} and ρ^{Ni} are the densities of Al and Ni, while M^{Al} and M^{Ni} denote the corresponding atomic weights.

Experimental data (as shown, for example, on page 426 of a book entitled “Selected Values of Thermodynamic Properties of Metals and Alloys” edited by Hultgren et al. and published by Wiley of New York City in 1963, the entirety of which is incorporated herein by reference) indicates that the variation of the heat of reaction, Q, with composition, C, can be closely approximated as:
Q(C)=ΔH_{f}C²
where ΔH_{f} is the heat of reaction. Thus, the averaged reaction source term can be expressed as:

$$\frac{\partial \overline{Q}}{\partial t} = - \overline{ρ {c}_{p}} Δ {T}_{f} \frac{\partial }{\partial t} ( \frac{1}{d} {\int }_{0}^{d} {C}^{2} ⅆ y )$$

where 2d is the thickness of an individual layer of the foil, y is the direction normal to the layers of the foil,

$$\overline{ρ {c}_{p}} ≡ \frac{{ρ}^{Al} {c}_{p}^{Al} + {γρ}^{Ni} {c}_{p}^{Ni}}{1 + γ}$$

cₚ^{Al} and cₚ^{Ni} respectively denote the heat capacities of Al and Ni. For a 1:1 reaction between Ni and Al, ΔT_{f}≡ΔH_{f}/\overline{pcₚ}=1660 K (as shown, for example, in U.S. Pat. No. 5,538,795, the '841 application, and the '352 application). Note that when melting is ignored, ΔT_{f} represents the difference between the adiabatic flame temperature, T_{f0}, and the ambient temperature, T₀.

Incorporation of melting effects may result in a complex relationship between H and T, involving the heats of fusion of the reactants and products (as shown, for example, in the '841 application and the '352 application). This relationship may be expressed as:

$$T = \{ \begin{matrix} {T}_{0} + \frac{H}{\overline{ρ {c}_{p}}} & if H < {H}_{1} \\ {T}_{m}^{Al} & if {H}_{1} < H < {H}_{2} \\ {T}_{m}^{Al} + \frac{H - {H}_{2}}{\overline{ρ {c}_{p}}} & if {H}_{2} < H < {H}_{3} \\ {T}_{m}^{Ni} & if {H}_{3} < H < {H}_{4} \\ {T}_{m}^{Ni} + \frac{H - {H}_{4}}{\overline{ρ {c}_{p}}} & if {H}_{4} < H < {H}_{5} \\ {T}_{m}^{NiAl} & if {H}_{5} < H < {H}_{6} \\ {T}_{m}^{NiAl} + \frac{H - {H}_{6}}{\overline{ρ {c}_{p}}} & if {H}_{6} < H\end{matrix}$$

where Tₘ^{Al}=933K, Tₘ^{Ni}=1728K and Tₘ^{NiAl}=1912K denote the melting temperatures of Al, Ni, and NiAl, respectively h_{f}^{Al}, h_{f}^{Ni}, and h_{f}^{NiAl} are the corresponding heats of fusion (per unit mole),

$$α ≡ \frac{1}{d} {\int }_{0}^{d} C ⅆ y$$

β≡α/(1+y) represents the fraction of pure (unmixed) Al at a given section ΔH_{f}^{Al}≡ρ^{Al}h_{f}^{Al}/M^{Al}, ΔH_{f}^{Ni≡ρ}^{Ni}h_{f}^{Ni}/M^{Ni}, ΔH_{f}^{NiAl}≡\overline{ρ}h_{f}^{NiAl}M^{NiAl}, \overline{ρ}≡(ρ^{Al}+γρ^{Ni})/(1+γ), H₁≡\overline{ρcₚ}(Tₘ^{Al}−T₀), H₂=H₁+βΔH_{f}^{Al}, H₃=H₂+\overline{ρcₚ}(Tₘ^{Ni}−Tₘ^{Al}), H₄=H₃+βγΔH_{f}^{Ni}, H₅=H₅+\overline{ρcₚ}(Tₘ^{NiAl}−Tₘ^{Ni}), and H₆=H₅+(1−α)ΔH_{f}^{NiAl}. Note that the “enthalpy” levels H₂, . . . , H₆ are dependent on the local composition, and are consequently variable during the computations. For instance, in the limiting case α=0, the product is absent and the temperature is only affected by melting of the reactants. Conversely, for α=1 mixing is complete and the temperature only depends on the heat of fusion of the product.

In another embodiment of this invention, the physical model may be implemented in its two-dimensional (“2D”), axisymmetric, or three-dimensional (“3D”) forms. The 2D and axisymmetric variants can be extrapolated to the 3D form. In the 2D formulation, a coordinate system (x,y) may be used such that x points along the direction of propagation, while y points in the direction normal to the layers of the foil. In the axisymmetric formulation, the equations may be solved in a cylindrical (r,y) coordinate system, with r and y respectively normal to the surface of the front and the layers of the foil. The axisymmetric and 2D models may share the same physical formulation outlined above. The primary difference concerns expressions of the gradient diffusion terms ∇·(k∇T) and V·(D∇C). In the 2D case, these may be expressed as:

$$∇ \cdot ( k ∇ T ) = \frac{\partial }{\partial x} ( k \frac{\partial T}{\partial x} ) + \frac{\partial }{\partial y} ( k \frac{\partial T}{\partial y} ) and$$

$$∇ \cdot ( D ∇ C ) = \frac{\partial }{\partial x} ( D \frac{\partial T}{\partial x} ) + \frac{\partial }{\partial y} ( D \frac{\partial C}{\partial y} )$$

while in the axisymmetric case we may have:

$$∇ \cdot ( k ∇ T ) = \frac{1}{r} \frac{\partial }{\partial r} ( k r \frac{\partial T}{\partial r} ) + \frac{\partial }{\partial y} ( k \frac{\partial T}{\partial y} ) and$$

$$∇ \cdot ( D ∇ C ) = \frac{1}{r} \frac{\partial }{\partial r} ( D r \frac{\partial T}{\partial r} ) + \frac{\partial }{\partial y} ( D \frac{\partial C}{\partial y} )$$

Other aspects of the formulation may remain essentially the same.

Note that in the 2D model, the self-propagating front may be planar, and move away from the plane of ignition. On the other hand, in the axisymmetric case the front may propagate radially outwards (e.g., away from the ignition source). Thus, the two models may enable analysis of different ignition modes. For instance, the axisymmetric case models ignition may be induced by a localized electrical spark, which may be observed experimentally to result in a cylindrically expanding front. Meanwhile, the 2D case may be relevant to the analysis of ignition induced by shearing the foil along its entire width, or by heating the foil along its side using a hot filament.

In one embodiment of this invention, a FORTRAN code may be used to implement the models outlined above. These models may be effectively implemented on a variety of computer platforms, such as Windows, Unix or Linux systems, including personal computers, laptops, workstations or mainframes. It should be evident for anyone skilled in the art how to implement this on any computing platform providing memory and processor, using either low- or high-level computing languages. These models may also be stored as an executable computer program on any computer readable medium, for example, a hard disk, floppy disk, and/or a compact disc.

In another embodiment of this invention, ignition requirements may be determined by initializing the computations using a thermal pulse of height Ho, and its width, Ws. In the 2D variant, the pulse may be located at one end of the foil, while it may be located at a centerline of the foil in the axisymmetric case. Outside the pulse region, the foil may be initially at ambient temperature, T₀; in the exemplary illustration below, T₀=298K. The computations may then be carried out over a time period that is long enough so as to observe the formation of the front and its propagation, if at all possible. Ignition requirements may be determined by systematically varying H₀ and Ws, and using the results of the simulations to identify the boundary of the region separating initial conditions that result in a self-propagating front, from those for which ignition does not occur.

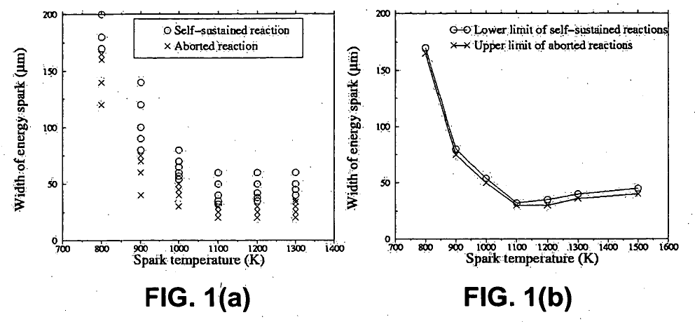

In one embodiment of this invention, the methodology set forth herein may be applied to determine critical ignition requirements of an axisymmetric source (e.g., cylindrically expanding front) for a Ni—Al foil with bilayer thickness 4d=40 nm (i.e., d=10 nm), and premix width 4w =2 nm (i.e., w=0.5 nm). As shown in FIG. 1a, repeated computations may be performed for different combinations of temperatures (“Ts”) and energy spark widths (“Ws”) and the results may be used to determine whether or not ignition occurs for each individual combination. The scatter plot of FIG. 1a and curves of FIG. 1b both use circles to depict combinations of Ts and Ws that resulted in a self-sustained reaction and uses crosses to denote combinations of Ts and Ws where the reaction was aborted or quenched. As shown in FIG. 1b, the results obtained for a given foil can be summarized by plotting the lower limit of the combinations leading to a self-sustained reaction, and the upper limit of the combinations for which quenching occurs. For this and other embodiments set forth herein, the ignition curve lies between these two limits.

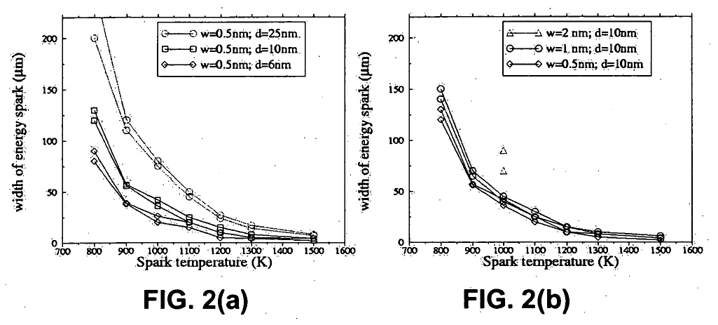

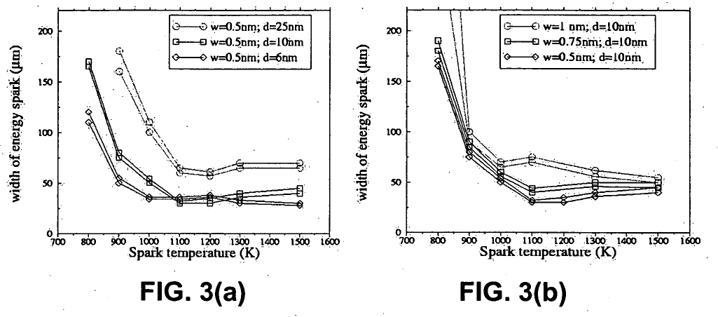

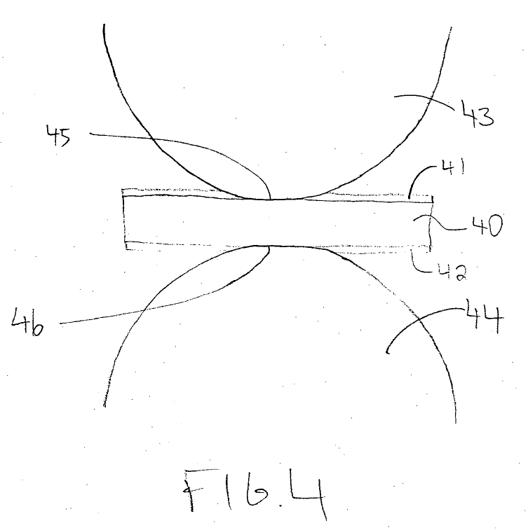

In another embodiment of this invention, the ignition (or stability) boundary resulting from the analysis outlined herein may be obtained for foils with different bilayer periods (4d) and premix widths (4w). Results for 2D fronts (i.e., planar fronts) having various bilayer periods d and premix widths w are shown in FIGS. 2a and 2b, and predictions for axisymmetric fronts (i.e., cylindrical fronts) having various bilayer periods d and premix widths w are plotted in FIGS. 3a and 3b. In FIGS. 2a-3b, two curves are shown for each shape. For each pair of curves, the upper curve in each of these figures denotes the lowest combination of Ts and Ws for which a self-sustained reaction occurred, while the lower curve denotes the highest combination of Ts and Ws for which, a reaction was quenched or aborted. For this and other embodiments set forth herein, the ignition (e.g., initiation of the chemical transformation) threshold for each set of corresponding bilayer periods d and premix widths w lies between the two curves corresponding to their respective shape.

The results of FIGS. 1a-3b reveal that the critical spark width (Ws) may decrease rapidly as the spark temperature (Ts) is increased. A plateau is then reached, where the critical spark width (Ws) becomes independent of the spark temperature. The stability results also indicate that critical conditions may be strongly affected by whether ignition is initiated along a plane or from a cylindrical tube. In the former case, as Ts increases the critical spark width may exhibit weak dependence on the bilayer period, 4d, and the premix width, 4w, and level off at about Ws=3-4 μm, for example, as shown in FIGS. 2a-2b. For cylindrical fronts, on the other hand, there may be greater variation in the critical spark width Ws when d and w are varied, ranging between about 28 μm and about 70 μm. For both modes of propagation, however, the results generally indicate that the height of the plateau at high Ts may not vary drastically with w, but that it may increase as d increases.

It should be evident for someone skilled in the art how to generalize the present results to other modes of propagation, and how to exploit critical ignition data to design power and energy requirements of various ignition sources.

In another embodiment of this invention, the multilayer ignition model outlined above may be extended to characterize initiation by an energy source, which may be localized and/or time-dependent. To this end, the section-averaged energy equation originally introduced as

$$\frac{ⅆ H}{ⅆ t} = ∇ \cdot ( k ∇ T ) + \frac{ⅆ Q}{ⅆ t}$$

may be generalized according to:

$$\frac{ⅆ H}{ⅆ t} = ∇ \cdot ( k ∇ T ) + \frac{ⅆ Q}{ⅆ t} + {q}^{′′′}$$

where q^{m} is the rate of energy generation associated with the energy source.

In embodiments of the invention, the generalized ignition model may be applied to characterize ignition (e.g., initiation of the chemical transformation) using an energy source (e.g., source of electrical current). In this situation, the energy source term q^{m} corresponds to Ohmic heating induced by the passage of the current, and can thus be expressed as:
q^{m}=σ∇Φ·∇Φ
where σ is the electrical conductivity and Φ is the electrical potential. The distribution of the electrical potential can be determined by solution of the conservation equation:
∇²Φ=0
with boundary conditions corresponding to the current source.

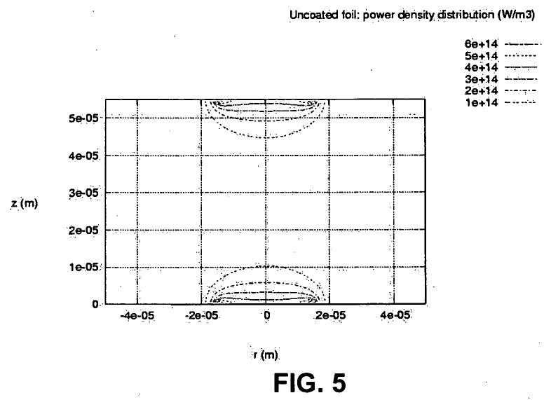

In another embodiment of the invention, the Ohmic heating ignition model outlined above may be applied to the configuration schematically shown in FIG. 4. FIG. 4 shows an enlarged view of a reactive multilayer foil 40, which may include one or more coating layers 41, 42 on one or more sides of the foil 40. Foil 40 is disposed between two electrical contacts 43, 44 (e.g., electrodes). Electrical contacts 43, 44 may each have any desired shape or dimensions, for example, they may each have a substantially semi-circular shape with a radius of about 3/32 of an inch. Electrical contacts 43, 44 may also each have a contact 45, 46 radius with foil 40 (and/or one of coating layers 41, 42) between about 15 μm and about 75 μm. The current may be modeled by imposing a constant potential flux at the contact area 45, 46, while zero potential flux is imposed at the remaining boundaries. The energy source (e.g., electrical source) may also be characterized by the pulse duration, outside which the Ohmic source term Φ may vanish identically. FIG. 5 depicts a power density distribution (W/m³) for the configuration in FIG. 4 where a current of 74 amps was applied to an uncoated Ni/Al foil having a thickness of about 55 μm. In FIG. 5, z(m) denotes a distance in meters in a direction perpendicular to a longitudinal axis of the foil, while r(m) denotes a distance in meters in a direction parallel to the longitudinal axis of the foil. FIG. 5 shows that for the configuration of FIG. 4, the power density may be non-uniform, and may peak near the electrode surface. Accordingly, the Ohmic heating term peaks in this region where reaction (e.g., chemical transformation) may be initiated (e.g. ignited).

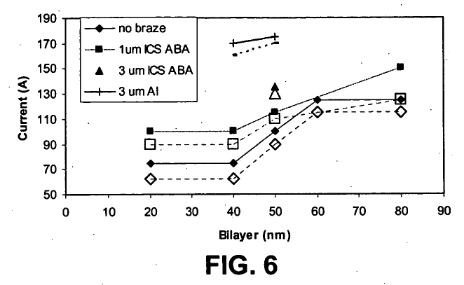

In another embodiment of this invention, the model may be applied to analyze the critical current needed to ignite 55 μm-thick Ni/Al multilayer foils. For example, FIG. 6 shows predictive results obtained for uncoated multilayer foils, as well as multilayer foils coated on either side with identical layers of Incusil or of aluminum. The Ni/Al multilayer's overall thickness and intermixing zone thickness are about 55 microns and about 2 nm, respectively, the contact radius between the electrode and the foil is about 15 microns, and the pulse duration is about 20 μs. Predictions shown in FIG. 6 include those where the foil is uncoated (diamonds), foils coated with about 1 micron thick layers of Incusil (squares), foils coated with about 3 micron thick layers of Incusil (triangles), and foils coated with about 3 micron thick layers of Aluminum (crosses). Consistent with these thermal initiation predictions, the results indicate that the critical current increases as the bilayer thickness increases. The results also indicate that the critical current needed for ignition increases as the thickness of the Incusil layer increases.

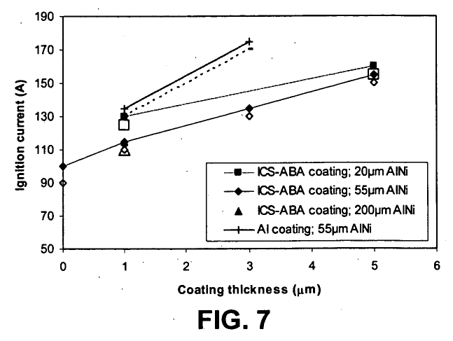

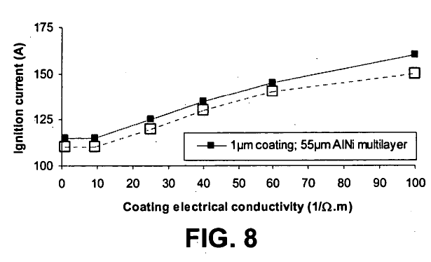

This effect is also illustrated in FIG. 7, where the effect of the thickness of the coating layer is further investigated. In some of the cases, as shown in FIG. 7, Incusil layers of about 1 micron were placed on the foil, and the foil thickness was varied to be one of about 20 microns (squares), about 55 microns (diamonds), and about 200 microns (triangles). In one of the cases, about 1 micron thick layers of Al were placed on a multilayer foil having a thickness of about 55 microns. The Ni/Al multilayer's overall thickness and intermixing zone thickness are about 50 microns and about 2 nm, respectively, the contact radius between the electrode and the foil is about 15 microns, and the duration of the pulse of the energy (e.g., pulse duration) from the electrode(s) is about 20 μs. Comparison of results obtained for coating layers of Incusil and aluminum indicate that the ignition requirements for the latter are substantially higher than that of the former. These differences may be traced to higher electrical conductivity of the aluminum. To support this assertion, the critical current needed for ignition (e.g., initiation of the chemical transformation) may be determined for different values of the electrical conductivity of the coating layer. The results, examples of which are shown in FIG. 8 (where the about 55 micron thick Al/Ni foil is covered on both sides with about 1 micron thick layers of braze; the Ni/Al overall thickness, intermixing zone thickness (e.g., thickness of the area in which the material in adjacent layers made of different materials are mixed), and bilayer thickness (e.g., thickness of a single layer of one material, such as Ni, combined with a single layer of another material, such as Al), are about 55 microns, about 2 nm, and about 50 nm, respectively, the contact radius between the electrode and the foil is about 15 microns, and the pulse duration is about 20 μs), may indicate that the critical current needed for ignition increases as the electrical conductivity of the coating layer increases. The filled squares in FIG. 8 indicate the lowest level at which a self-sustained reaction may occur, while empty squares indicate the highest level at which a reaction is aborted or quenched, with the ignition curve lying between the two. Combined, the results of FIG. 6-8 may indicate that the ignition requirements can be controlled by controlling both the thickness and/or material properties of coating layers.

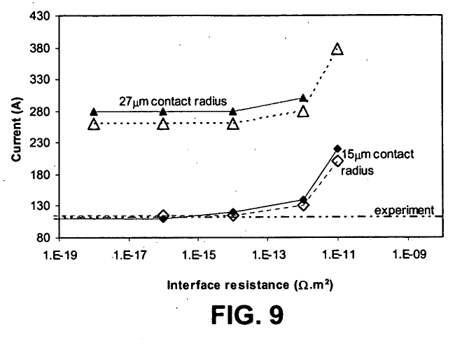

In another embodiment of this invention, the model may applied to analyze the effect of electrical interface resistance on the critical current needed for ignition (e.g., initiation of the chemical transformation). For example, in an application of the model as shown in FIG. 9, the parameters used were about 1 micron thick layers of Incusil placed on the foil, the Ni/Al foil having overall, intermixing, and bilayer thickness of about 55 microns, about 2 nm, and about 50 nm, respectively, and the pulse duration being about 20 μs. The circles denote a contact radius of about 27 μm and the diamonds denote a contact radius of about 15 μm. The filled shapes indicate the lowest level at which a self-sustained reaction may occur, while empty shapes indicate the highest level at which a reaction is aborted or quenched, the ignition curve being disposed between the two. The results shown in FIG. 9 for the about 55 μm-thick Ni/Al foil indicate that for this reactive multilayer foil, an interface resistance of less than about 10⁻¹⁵ Ωm² has minimal impact on the current needed for ignition (e.g., critical current). For larger values on the other hand, the critical current rises sharply with interface resistance. Thus, the present predictions illustrate an additional means of controlling electrical ignition properties.

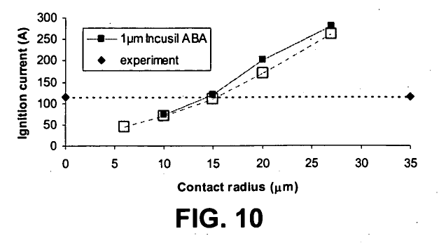

In another embodiment of this invention, the model is applied to analyze the effect of electrode contact area on the critical current needed for ignition. For example, in an application of the model as shown in FIG. 10, the parameters used were about 1 micron thick layers of Incusil placed on the foil, the Ni/Al foil having overall, intermixing, and bilayer thickness of about 55 microns, about 2 nm, and about 50 nm, respectively, and the pulse duration being about 20 μs. The filled shapes in FIG. 10 indicate the lowest level at which a self-sustained reaction may occur, while empty shapes indicate the highest level at which a reaction is aborted or quenched, the ignition curve lying in between the two. The results shown in FIG. 10 for an about 55 μm-thick Ni/Al reactive multilayer foil indicate that as the contact area increases, the current needed to ignite the foil increases as well. Thus, the electrical ignition properties can be controlled by controlling the contact area between the electrode and the foil, which can itself be controlled by varying the size of the electrode as well as the pressure applied by the electrode at the foil surface.

In another embodiment of this invention, the model predictions in FIGS. 9 and 10 may be compared with experimental measurements of the same configuration. A nominal contact radius of about 20 μm may be used in the experiments. Comparison of computational and experimental results reveals reasonable agreement, and indicates that the computations yield conservative predictions of the critical current. The deviations between measurements and predictions may be traced to imperfections in the electrode surface, which results in a smaller effective contact radius. Note that in the experiments, the voltage applied to drive the critical current is less than about 2V. This may be a useful advantage when mounting microelectronic components which may be sensitive to high voltages.

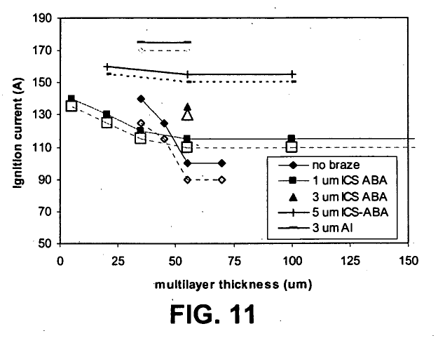

In another embodiment of this invention, the model is applied to analyze the effect of foil thickness on the critical current needed for ignition (e.g., initiation of the chemical transformation). Results are shown in FIG. 11 for a Ni/Al foil having overall, intermixing, and bilayer thickness of about 55 microns, about 2 nm, and about 50 nm, respectively, a contact radius between the electrode and foil of about 15 microns, and the pulse duration being about 20 μs. Predictions are shown for uncoated foils (diamonds), foils with about 1 micron thick layers of Incusil (squares), foils with about 3 micron thick layers of Incusil (triangles), foils with about 5 micron thick layers of Incusil (crosses), and foils with about 3 micron thick layers of Al (dashes). The filled shapes indicate the lowest level at which a self-sustained reaction may occur, while empty shapes indicate the highest level at which a reaction is aborted or quenched, the ignition curve lying in between the two. For the present configuration and ignition mode, the results indicate that for a multilayer foil thickness larger than about 50 μm, the critical current may be weakly dependent on the foil thickness. On the other hand, for thinner multilayer foils, the critical current may rise as the foil thickness decreases.

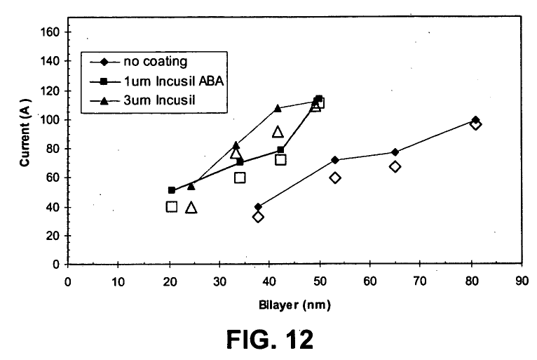

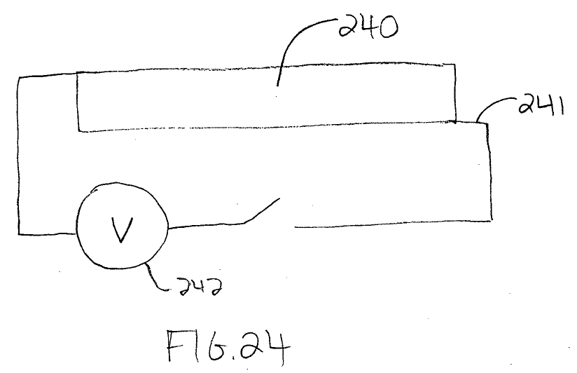

In another embodiment of this invention, the dependence of the critical ignition stimulus on the bilayer period (e.g., thickness) of the reactive multilayer may be verified experimentally. Results are provided here using two ignition methods, namely Joule heating (see FIG. 23) and mechanical impact. FIG. 12 shows the dependence that ignition thresholds may have based on bilayer period for both coated and uncoated Ni/Al multilayer foils. For this experiment, the electrodes used are about 3/16 of an inch (about 4.7 mm) in diameter, yielding contact areas of about 2.6 to 2.7×10⁻⁹ m². The electric current is applied for a pulse duration of about 20 μs. Results are shown for uncoated foils (diamonds), foils with about 1 micron thick layers of Incusil (squares), foils with about 3 micron thick layers of Incusil (triangles). Consistent with model predictions, the experimental measurements shown in FIG. 12 indicate that the critical current needed for ignition increases with bilayer period, that the critical current is larger for coated foils than for uncoated foils, and that it increases as the thickness of the coating layer increases.

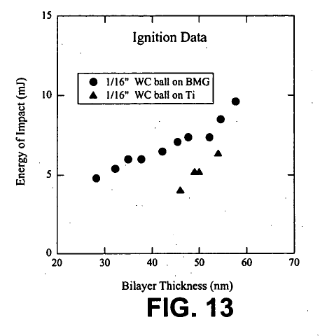

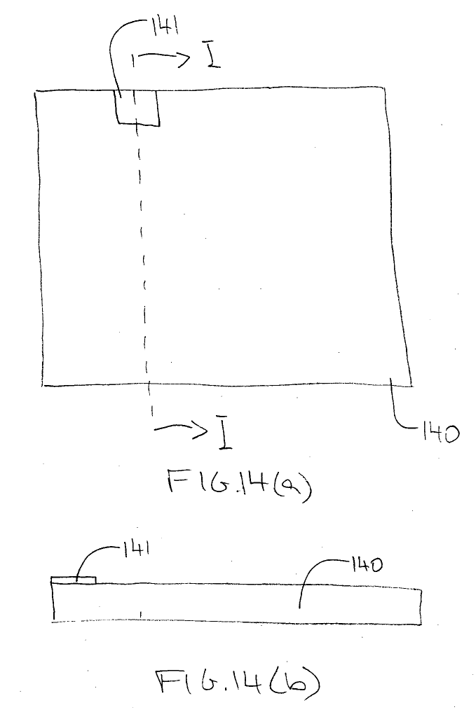

FIG. 13 shows results obtained for ignition induced by the mechanical impact of a tungsten-carbide (WC) sphere onto Ni/Al multilayer foils. The critical mechanical energy needed for initiation of the chemical transformation (e.g., reaction) is plotted against bilayer period. FIG. 13 shows the results of two sets experiments: in one, the Ni/Al multilayer foils are positioned onto a bulk metallic glass (BMG) substrate; and in the other, they are placed on a titanium (Ti) substrate. Consistent with earlier computational and experimental predictions, the results in FIG. 13 indicate that the critical mechanical energy needed for ignition increases with bilayer period. The results also indicate that the critical energy is larger for multilayer foils held onto BMG substrates (circles) than those held onto Ti substrates (triangles). The differences between the two cases may be attributed to different energy absorption characteristics between the two substrate materials, as well as differences in thermal conductivity. Relative differences may be as large as 100% for the smaller bilayers but, are substantially smaller as the bilayer increases. Thus, the results indicate that critical energy requirements may be conservatively estimated by analyzing thicker bilayers and multilayer foils confined between softer surfaces with higher thermal conductivity.

Note that in many reactive multilayer foil applications, including soldering, brazing, welding, as well as the use of other reactive multilayer foils as ignitors, it may be advantageous to select as small as possible an energy source (e.g, source of current). For both spark-ignition and ignition induced by Joule heating, this may offer the advantage of reducing cost, minimizing space requirements, and/or limiting potential damage to neighboring components. Parametric studies were conducted using the model outlined above, ignition tests were performed using a spark, and Joule-heating experiments were performed in order to determine a range of conditions that would address the requirements above. These studies indicate that for most multilayer systems, a pulse (e.g., electrical pulse) of about 40 mJ or less may be sufficient for ignition (e.g., initiation the chemical transformation) of most multilayer foils. In addition, the studies also revealed that critical ignition energies may be delivered using an electrical potential of about 10V or less. Note that in the case of reactive joining of microelectronic components, it may be desirable to further limit the electrical potential to about 5V or about 1V, so as to eliminate potential damage to these sensitive components. Regarding pulse durations, model computations indicate that these are preferably smaller than the thermal diffusion time across the multilayer foil, in order to avoid significant dissipation of heat from the ignition zone. Typically, reactive multilayer foils are fabricated from metallic systems having thermal diffusivities of the order of about 10⁻⁵ m²/s, and in most applications, a multilayer foil thickness on the order of about 100 microns may be used. Thus, diffusion times, estimated as the square of thickness divided by the thermal diffusivity, are on the order of about 1 ms. Consequently, the duration of the electrical stimulus (e.g., pulse duration) is preferably smaller than this value. Within this range of conditions, for Joule heating, it may possible to limit the contact area so that the equivalent diameter is about 1 mm or smaller. The present embodiments may be immediately applicable to a wide range of multilayer ignition applications.

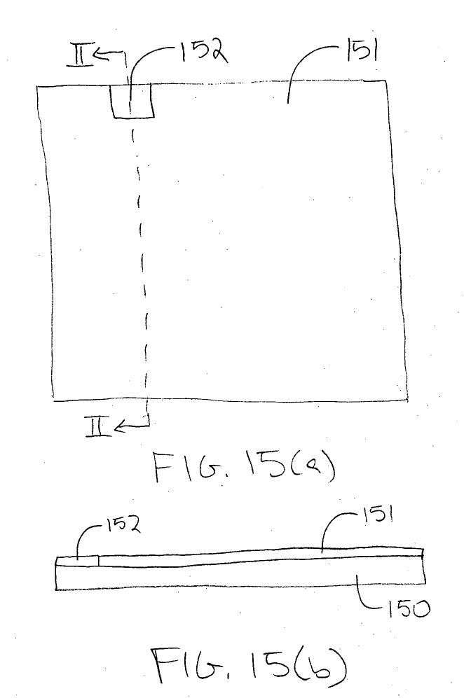

In another embodiment of this invention, a laser may be used to ignite (e.g., initiate a chemical transformation) a reactive multilayer foil that is coated with a material having high absorption to the laser. Ignition may occur when the narrow coherent intense laser beam of either infrared or visible light rapidly heats the surface of the foil, resulting in ignition. An example includes coating a Ni/Al reactive foil with thin layers of In solder. Since In is more absorbing than the constituents of the foil, lower energy requirements for the laser source can be achieved. An alternative configuration is shown in FIGS. 14(a) and 14(b), where the foil 140 may be partially coated with a highly absorbing material 141 such as carbon black. Another variant is shown in FIGS. 15(a) and 15(b), where the foil 150 may coated with a highly reflective material 151 except for a small area that is coated with a highly absorbing material 152, for example, silver or other materials more reflective than nickel or aluminum. The advantage of the latter configuration may be that it provides greater control of the location of ignition.

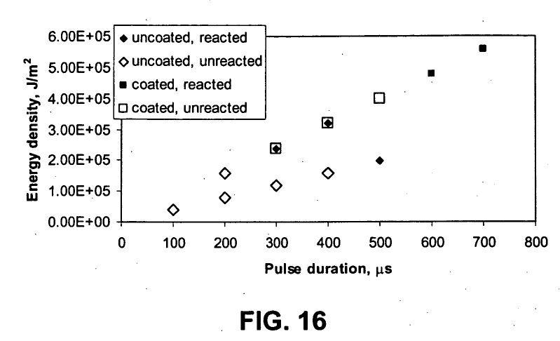

In another embodiment of this invention, laser ignition of reactive multilayer foils is tested experimentally. FIG. 16 shows ignition thresholds for both coated and uncoated Ni/Al multilayer foils based on variations in energy density and pulse duration. The materials used in both cases (shown using diamonds and squares, respectively) were a Ni/Al reactive multilayer foil having an overall thickness of about 50 microns and a bilayer thickness of about 60 nm. The squares denoted foils also having a layer of InCuSil approximately 1 micron in thickness disposed on the foil. Filled shapes denote combinations where a self-sustained reaction occurred, while empty shapes denote combinations where the reaction was quenched or aborted. The laser used was a 100 W, continuous, 1085 nm wavelength laser, however, in various embodiments, the laser may be any laser and/or have any appropriate configuration known in the art. Consistent with earlier findings, the results indicate that the presence of a braze coating generally inhibits ignition, so that higher energy densities and/or pulse durations may be needed than for uncoated multilayers.

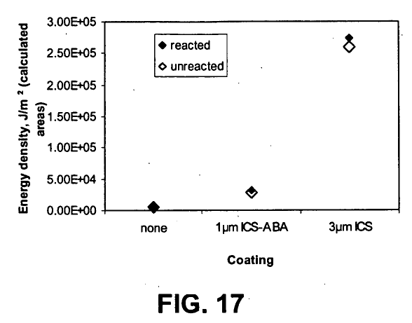

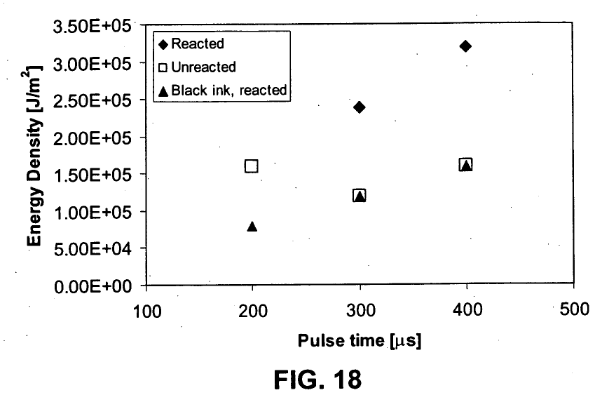

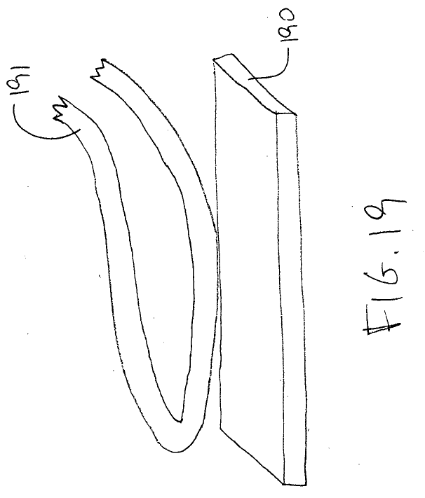

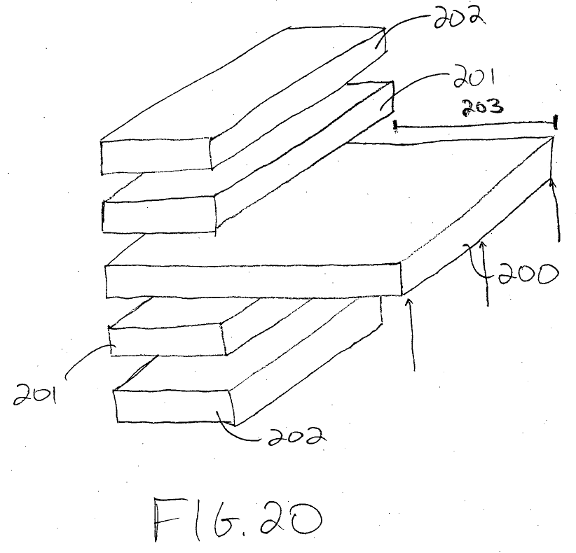

This trend is also evident in FIG. 17, which shows the variation of ignition requirements with the thickness of the braze layer. The laser used here for ignition was a Q-switched (pulsed), Nd:YAG, 1065 nm wavelength laser at a pulse or pulses (e.g., both of which are included in the term pulse duration as set forth in this application) of about 8 ns. Filled shapes denote combinations where a self-sustained reaction occurred, while empty shapes denote combinations where the reaction was quenched or aborted. However, as mentioned earlier, the ignition requirements may be reduced if a thin coating having high absorptivity with respect to the laser emission is present at the target spot. For example, as shown in FIG. 18, the reactive multilayer foils coated with black ink (triangles) require less energy density for ignition than the same multilayer foils without the black-ink coating. The foil used in connection with FIG. 18 had a thickness of about 60 microns and a bilayer period of about 65 nm. The filled diamonds in FIG. 18 denote combinations of energy density and pulse time where a self-sustained reaction occurred, while the empty squares denote combinations were the reaction was quenched or aborted.

In another embodiment of this invention, a variety of laser sources have been tested, including both continuous, pulsed, and/or switched laser. These tests have focused, in particular, at determining a range of pulse conditions suitable for joining and ignition applications. Results of these tests indicate that a wide range of wavelength may be possible. However, the wavelength is preferably selected above the ultraviolet range (about 300 nm) in order to avoid potential ablation of the foil or foil-coating, which may occur at smaller wavelengths. Wavelengths in the range of about 300 nm to about 2 microns are satisfactory and may ensure good absorption by the uncoated multilayer foil or by the multilayer coating. As for the discussion of electrical ignition, laser pulse durations should be smaller than the diffusion time scale through the foil, which may be about 1 ms in most applications. Results of the experimental measurements indicate that these requirements can be achieved using laser sources having a power output of about 300 W or smaller, with a spot size smaller than about 1 mm, and an energy level of 40 mJ or less.

In another embodiment of this invention, the reactive multilayer foil may be ignited using a microwave source. Microwaves may cause a charge to accumulate at a portion of the reactive foil (e.g., sharp, pointed edges and/or tips of the foil), resulting in an electric discharge and ignition of the foil. In this mode of ignition, the reactive multilayer foil may be embedded in a structure including materials which are poor absorbers of microwave energy, such as polymers or borosilicate glass. The advantage of this mode of ignition is that it does not require direct access to the reactive foil.

In another embodiment of this invention, the reactive multilayer foil may be ignited using an ultrasound source. An illustrative geometry is a foil sandwiched between two components. The ultrasonic source may be applied to one component of a sandwich which then vibrates relative to a stationary second component of the sandwich. The resulting frictional heating may then result in the ignition of the foil. Similar to microwave ignition, this method also offers the advantage that it does not require direct access to the reactive foil. Thus, at the time of ignition, the latter may be embedded within a structure or shielded from the source by other components.

In another embodiment of this invention, the reactive multilayer foil may be ignited by a penetrating projectile. The foil may be embedded in a metal, ceramic, or polymer sandwich-like structure. Upon impingement of the projectile a mechanical and/or thermal energy burst may be supplied to the foil resulting in ignition. The advantage of this mode of ignition may be that the reactive foil can be embedded within a structure that is pierced by the penetrating projectile. Thus, direct foil access need not be provided prior to ignition in this embodiment as well.

In another embodiment of this invention, as shown in FIG. 19, the reactive multilayer foil 190 may be ignited using induction heating. In this technique, a very strong rapidly alternating magnetic field (e.g., from induction coil 191) may induce eddy currents in an electrically conductive reactive foil 190 placed in the field. This mode of ignition may also offer the advantage that direct access to the foil 190 is not required in order to initiate the reaction. A variant of this approach concerns reactive multilayer foils containing a magnetic element such as Ni. For such multilayer foils, induction heating effects may be further amplified by hysteresis and/or eddy-current losses, and as a result the critical power requirements of the ignition source may be reduced.

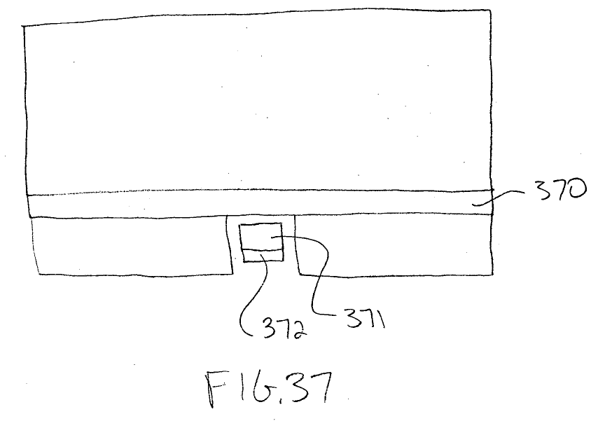

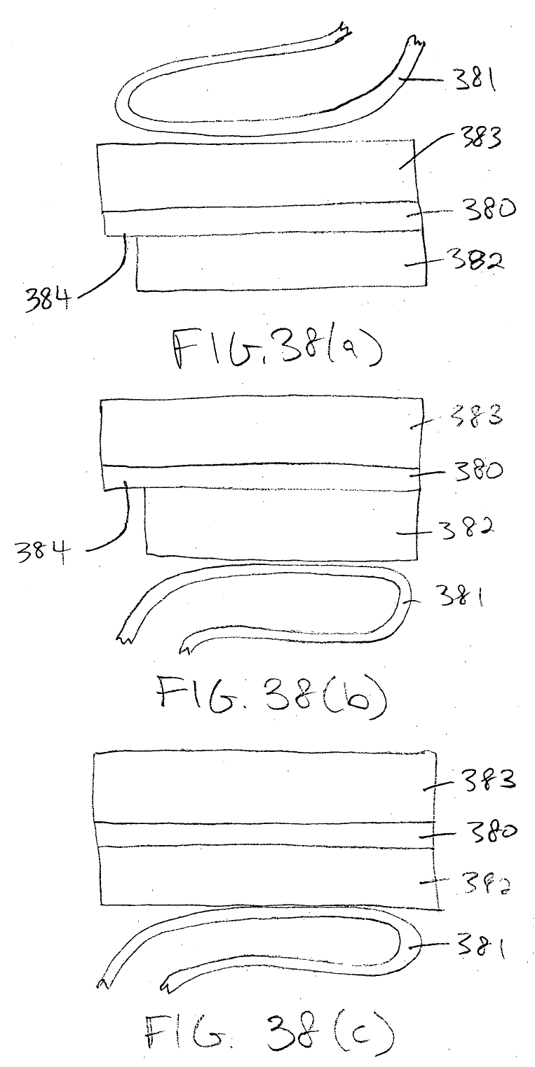

In another embodiment of this invention, initiation of reactive Ni/Al multilayers using induction heating using the model set forth herein may be verified experimentally. The induction unit 191 used in the experiments may include an RF power supply at about 1 kW with a built-in heat sink, operating over a frequency range of about 150 kHz to about 400 kHz. The induction unit may vary automatically depending on the heating coil used. Using a helical coil 191 (e.g., about 1 inch in diameter by about 1 inch tall) and a no-load current of about 140 A, Ni/Al multilayer foils 190 may be ignited rapidly, for example, when held horizontally above the coil 191 as opposed to vertically. The multilayer foils used in these tests were about 60 microns thick with about a 50 nm bilayer. Multilayer foils 380 that were placed between two silicon wafers 383 also ignited readily. Ni/Al multilayers 380 placed between a silicon wafer 383 and a block of titanium 382 ignited only if a corner 384 of the foil 380 extended beyond the titanium, for example, as shown in FIG. 38(b). Ignition was possible typically if the silicon 383 was between the coil 381 and the foil 380, for example, as shown in FIG. 38(a). On the other hand, metal 382 between the coil 381 and the foil 380, for example, as shown in FIG. 38(c) shields the foil 380 and ignition did not occur. It should be evident for someone skilled in the art how to generalize the present findings to selected suitable configuration and to account for possible shielding effects.

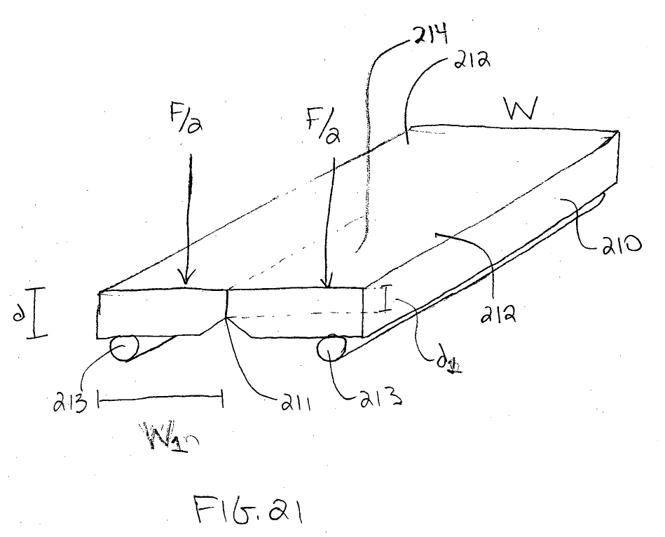

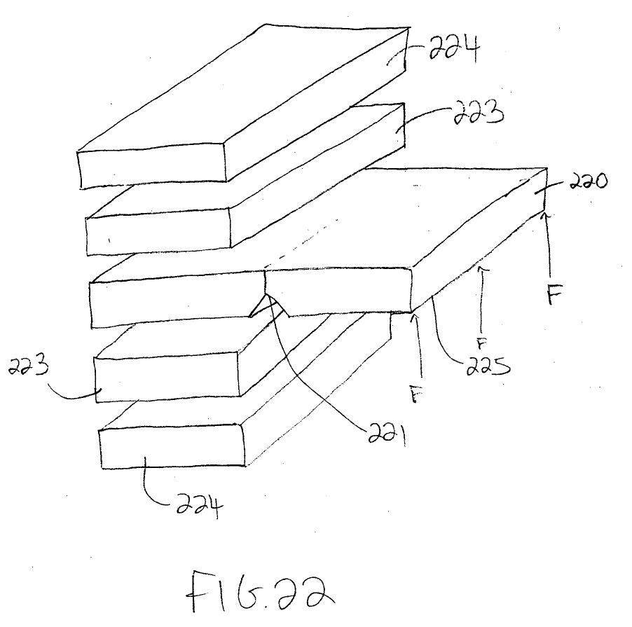

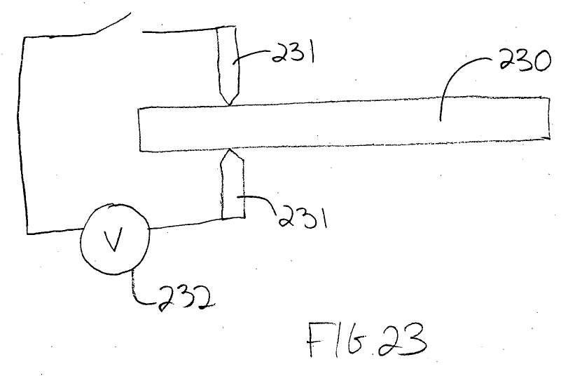

In another embodiment of this invention, the reactive foil may be ignited using mechanical fracture. Mechanical fracture results in the release of stored and applied energy. When the energy released is greater than the energy required for ignition, initiation of a self-propagating reaction occurs within the multilayer foil. An example is provided in FIG. 20, which illustrates the application of this mode of ignition to reactive multilayer joining. In the example shown in FIG. 20, ignition requirements can be modulated by varying the protruding length 203 of foil 200 relative to solder/braze components 201 and/or joining components 202. Another means of controlling ignition consists of engineering a groove 211, 221 (e.g., recessed portion) into the reactive foil to concentrate the energy. As illustrated in FIGS. 21 and 22, application of a bending force F (e.g., with F/2 being applied to each section 212 of foil 210) may lead to crack propagation within the foil 210, 220 (e.g., at groove 211, 221, respective), and consequently initiate the reaction. In various embodiments, the force F applied to each section 212 may vary based on the geometries (e.g., position W₁ of groove 211, 221 relative to width W, and position di of groove 211, 221 relative to depth d) of section 212 relative to foil 210 The force F can be applied either in a point, edge, or surface geometry. These arrangements offer the possibility of controlling ignition by varying the applied force and/or the features of the groove. For example, FIG. 21 depicts portions 212 disposed on support rods 213, with groove 211 being disposed between opposing portions 212 and support rods 213. Force F may the be applied to the side 214 of foil 210 opposite groove 211. In another example, FIG. 22 depicts portion 222 protruding from solder/brazes 223 and joining components 224, with a bending force F being applied to end 225 of foil 220 on the side of foil 220 including groove 221.

In another embodiment of this invention, the reactive foil may be ignited via electrical-current-induced Joule heating. This approach differs from approaches where current is induced via electrical spark discharge. As illustrated in FIGS. 23 and 24, in the present embodiment the reactive foil 230, 240 may be in contact with electrical leads 231, 241 through which the current flows. In FIG. 23, leads 231 are placed on substantially opposite sides of foil 230, while in FIG. 24, leads 241 may be placed on opposite ends of foil 240. The current may be generated using a variety of means, for example, by a voltage source 232, 242, a current source, a charged capacitor, a piezoelectric device, a thermoelectric device, and/or a ferroelectric device. Compared with spark discharge, the present approach offers the advantage of greater control over the power and total energy delivered into the foil, as well as the size of the heated region, thereby facilitating application of the design methodology discussed herein.

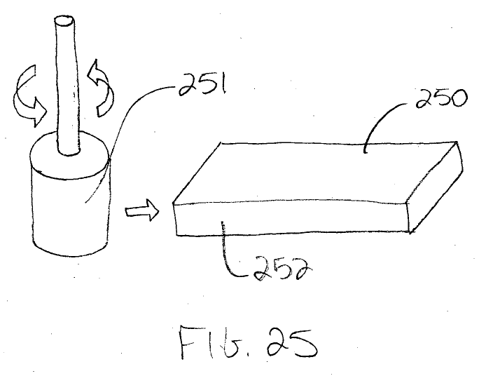

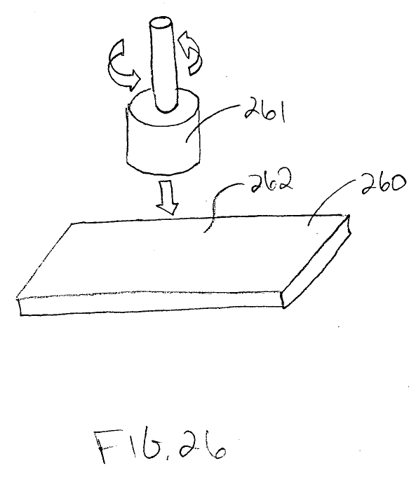

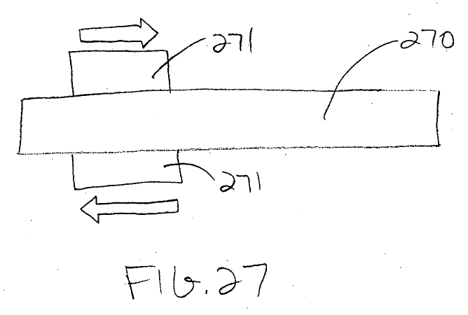

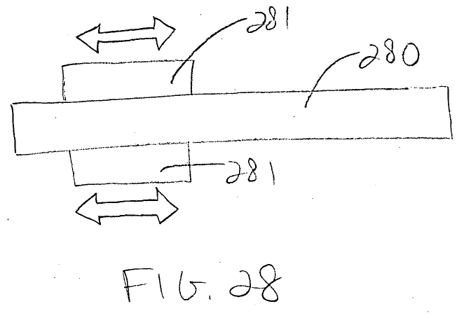

In another embodiment of this invention, the reactive foil may be ignited (e.g., the chemical transformation may be initiated) using mechanical friction. Friction with rough objects is used to generate localized intense heating of the foil, which consequently triggers the reaction. Examples of such rough objects include an abrasive rotary tool bit, or a diamond wheel. A variety of means can be implemented for triggering the reaction using rough objects. For example, FIGS. 25 and 26 illustrate rotating a rough object 251, 261 and placing rough object 251, 261 in contact with a side surface 252 and a top surface 262 of foils 250, 260, respectively. In other examples, FIGS. 27 and 28 disclose placing one or more rough objects 271, 281 against one or more surfaces of foil 270, 280, and then moving one or more of rough objects 271 in one direction or in opposite directions relative to foil 270 (as shown in FIG. 27). Alternately, as shown in FIG. 28, one or more rough objects 281 may vibrate relative to foil 280 to create friction heating. The vibration and/or movement of one or more rough objects 271, 281 may be substantially synchronized or unsynchronized. These methods may offer the advantage that the moving rough surfaces may be embedded into a structure, as further discussed below.

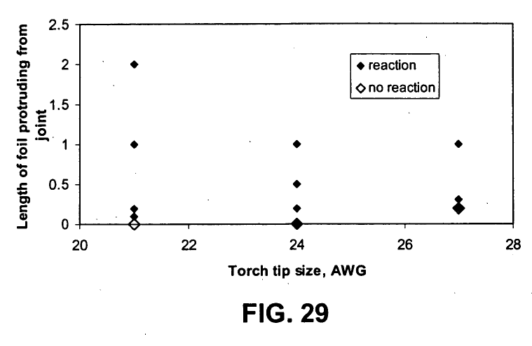

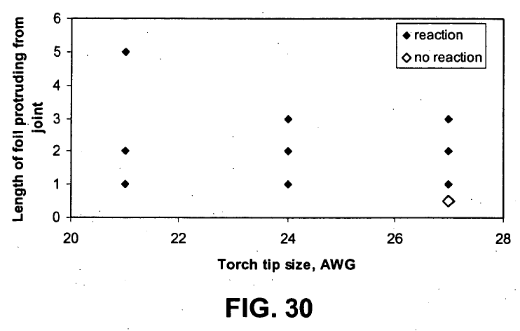

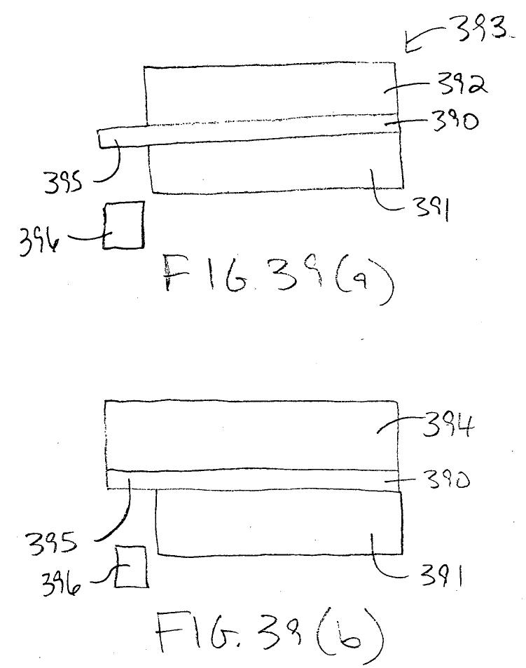

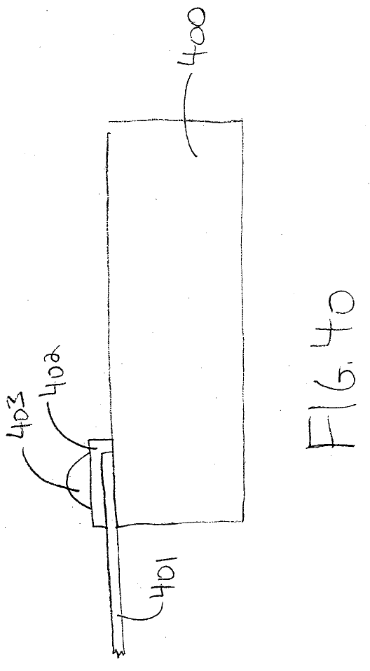

In another embodiment of this invention, ignition of the reactive multilayer foil may be triggered by a microflame. Microflames are widely used in soldering operations, and their availability provides an added advantage in reactive soldering or brazing applications. The usefulness of microflames 395 as ignitors for reactive multilayer foils 390 has been tested experimentally using two different setups. In the first case, for example, as shown in FIG. 39(a), the multilayer foil 390 may be positioned between two copper blocks 391, 392 having the same size and, and a portion 395 of the foil 390 may freely protrude out of one the sides of the assembly 393; this arrangement is referred to as a protruding configuration. In the second case, for example, as shown in FIG. 39(b), the multilayer foil 390 may be positioned between two copper blocks 391, 394 of unequal size, and the protruding portion 395 of the multilayer foil 390 may remain in contact with the larger copper block 394; this arrangement is referred to as a partially-protruding configuration. In both the protruding and partially-protruding configurations, an Ni/Al foil having a bilayer thickness of about 50 nm may be used. FIGS. 29 and 30 show hydrogen microflame ignition results for both configurations. In both FIGS. 29 and 30, results are provided for torch tip sizes 21, 24, and 27 on the AWG scale. As shown in the figures, hydrogen microflames may be quite effective at igniting reactive multilayer foils (filled diamonds), as in only a few cases where only a small portion of the foil was protruding was the reaction aborted and/or quenched (unfilled diamonds). The results also show that the presence of a small local protrusion may assist ignition, especially when the foil remains in contact with a material having large thermal conductivity.

In another embodiment of this invention, ignition of the reactive multilayer foil may triggered by rapid heating of an entire assembly in which the multilayer foil is disposed. Examples include reactive joining configurations where the assembly is rapidly heated, for example in a reflow furnace or oven, to reach the foil autoignition temperature. These heating rates and/or autoignition temperature may be readily determined by differential scanning calorimetry (DSC) or by actual heating of the assembly. For instance, for Ni/Al multilayers, DSC measurements reveal that the ignition may be initiated if the foil is heated at a rate of about 200° C. per minute or faster, when its temperature reaches about 240° C. These findings were further amplified by subsequent studies using a hot plate, which indicate that reactive a Ni/Al multilayer foil may ignite when dropped into molten Pb—Sn solder having a temperature of about 210° C. The molten solder provides very good heat transfer from the hot plate to the foil, providing for very high heating rates, thus initiating the reaction (e.g., chemical transformation). This method may have the added advantage that direct access to the foil is not required, which provides a substantial advantages in reactive multilayer joining applications. Other advantages may also include a smaller thickness of the reactive multilayer foil required for joining, resulting in reductions in material weight, cost, and/or bond-line thickness.

In another embodiment of this invention, the above method may be modified by providing rapid heating from one side of an assembly that comprises a reactive multilayer foil. Examples include reactive joining applications, where rapid heating may be provided by raising the temperature of a heat spreader or a heat sink, or selectively driving high current through a microelectronic device.

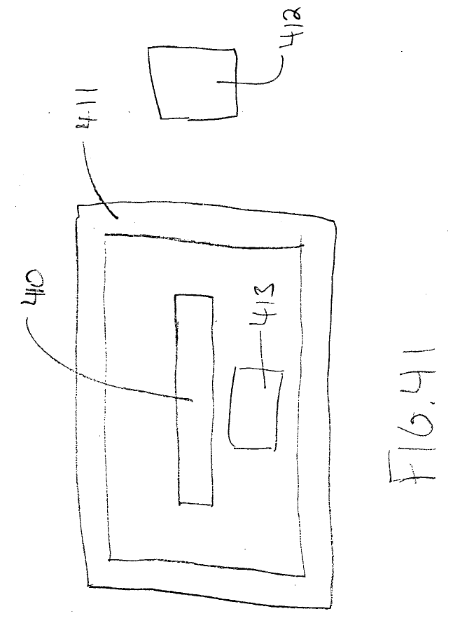

In another embodiment of this invention, heat generated by a chemical reaction may be used to ignite the reactive multilayer foil. Examples that have been tested include the use of a self-propagating high-temperature synthesis (SHS) reaction in a mixture of nano-aluminum and iron oxide. The setup that was tested, as shown in FIG. 40, comprised a wire filament 401 in tape 402 (e.g., Kapton tape) attached to the reactive foil 400, with a small pile of the SHS mixture (e.g., powder) 403 positioned on top of the tape 402. When the filament 401 was heated electrically, it ignited the SHS mixture 403, which in turn ignited the reactive multilayer foil 400.

It should be evident for anyone skilled in the art how to generalize the above embodiments to conceive a variety of ignition systems.

In many applications involving reactive joining and hermetic sealing, direct access to the foil may be limited at the instant the foil is to be ignited. This may be the case when the foil 410 is embedded into an assembly 411, for example, as shown in FIG. 41, and the assembly 411 either partially or fully shields the foil 410 from direct contact with an external ignition source 412, or substantially prevents a user from physically triggering an internal ignition source 413. Examples of both external and internal ignition sources include one or more of a voltage source, a current source, a charged capacitor, a piezoelectric device, a thermoelectric device, an RF source, an ultrasound source, an electromagnetic source, a microwave source, a thermal source, a source of induction heating, a ferroelectric device, a firing pin, a laser, a MEMS device, a hot filament, a solenoid, a gated switch, an abrasive surface, a microbubble, a fuse, a multilayer tab, and SHS powder, and a heated gas. As outlined earlier, this invention introduces means to overcome such limitations.

In one embodiment of this invention, an ignition method is used that naturally overcomes access limitations. Examples include microwave and ultrasound sources that are discussed above.

In another embodiment of this invention, an optical path may be provided within the assembly so as to enable delivery of a stimulus generated by a laser source. An example is provided in the schematic of FIG. 31, which shows a slot 312 machined into one of the components 311 being reactively joined. The slot 312 may provide an optical path for the stimulus 313 (e.g., light or laser beam) from the laser source 314, and thus may enable laser-ignition of the reactive foil 310.

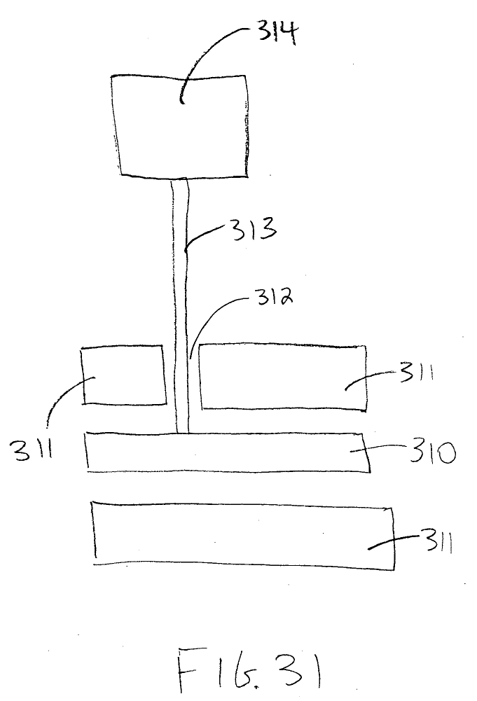

In another embodiment of this invention, an optical system may be used in conjunction with a laser source in order to overcome access limitations. An example is provided in the schematic of FIG. 32, which illustrates the use of an energy reflecting material 321, such as a mirror, to direct the laser energy 322 to the ignition spot of the foil 320 disposed between components 323 to be joined.

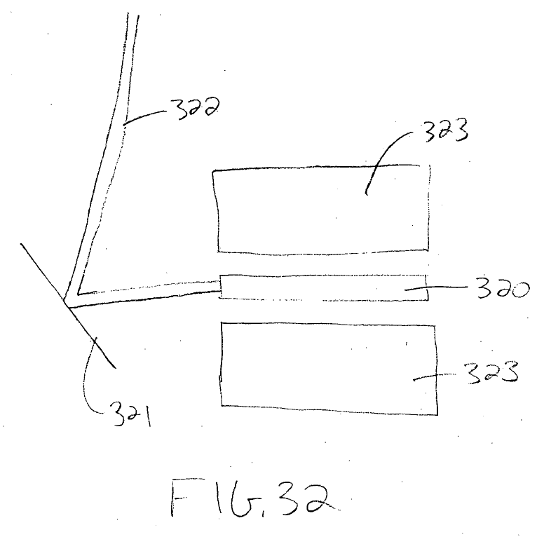

In another embodiment of this invention, the stimulus from the laser source may delivered using a fiber-optic cable 331 to foil 330 disposed between joining components 332, for example, as schematically illustrated in FIG. 33. Similar to the previous example, this approach also provides an effective means for overcoming the lack of a direct optical access to the ignition spot.

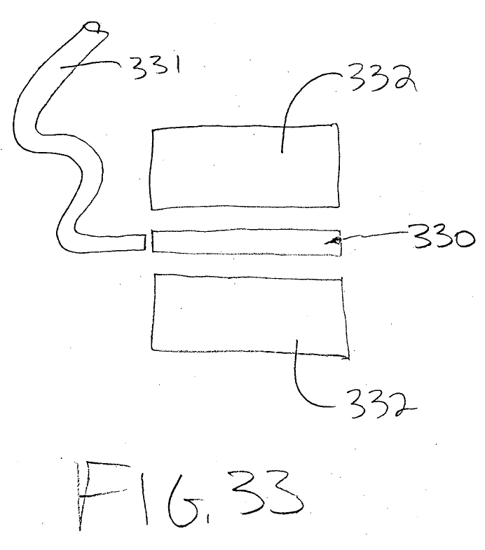

In another embodiment of this invention, the stimulus of an energy source (e.g., source of electrical power) may be delivered using an electrical lead embedded within the assembly. An example is shown in the schematic of FIG. 34, which illustrates the use of an embedded electrical lead in a reactive joining application. The embedded lead 341, which may be isolated from other components 342, 343 in the assembly (e.g., by being disposed in a slot 344 of component 342), may either be in direct contact with the reactive foil 340, so as to allow arc-free passage of electrical current, or positioned close to the reactive foil 340, in which case ignition follows arc-discharge of electrical energy. As mentioned earlier, the electrical source may comprise one or more of a voltage source, a current source, a charged capacitor, a piezoelectric device, a thermoelectric device, or a ferroelectric device.

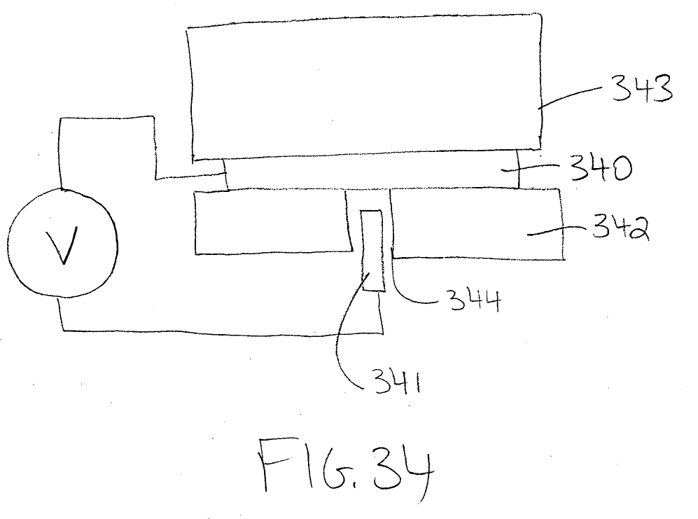

In another embodiment of this invention, the stimulus of an electrical power source may be delivered using a thin electrical lead, which may be in the form of a thin electrical wire or a thin metallic sheet, for example, as shown in FIGS. 35(a) and 35(b). Electrical lead 351 may be coated with an electrically insulating material, which may minimize the likelihood of current leakage into electrically conducting component 352, and may be disposed in a slot between component 353 and electrically conducting component 352. Electrical lead 351 may be made of a material that does not melt at low temperatures so as to facilitate removal of 351 from the assembly without contaminating the area around the joint with conductive particles. Lead 351 may or may not be in direct contact with the multilayer foil 350, and the power source may comprise a voltage source, a current source, a charged capacitor, a piezoelectric device, a thermoelectric device, or a ferroelectric device.

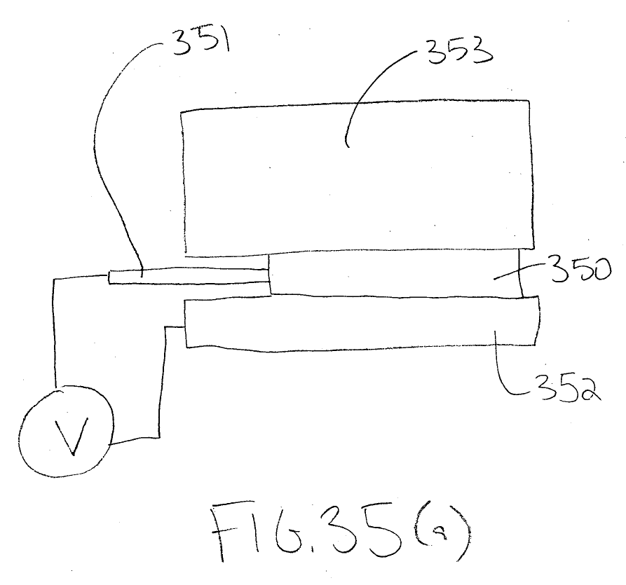

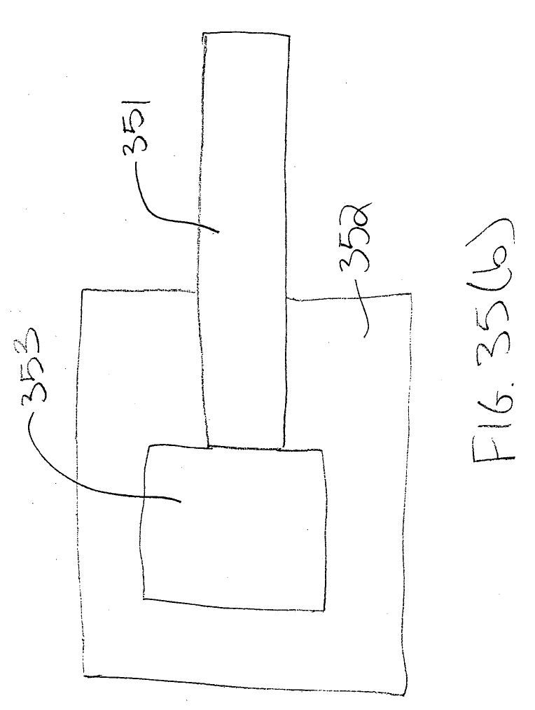

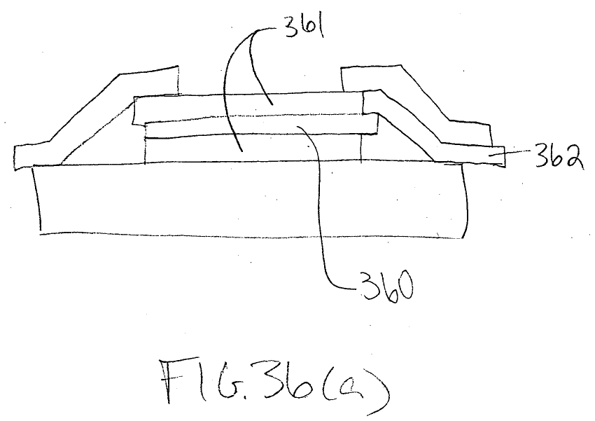

In another embodiment of this invention, access limitations may be overcome using a fuse, which may comprise a fusible wire or a tab of reactive multilayer material. An example is shown in FIGS. 36(a)-36(c), which illustrates the use of reactive multilayer tab in a reactive joining application. In such a case, foil 360 may have solder 361 disposed on both sides, and may be electrically connected to fuse 362 configured to be activated by an external or internal energy source 363 (e.g., a voltage source).

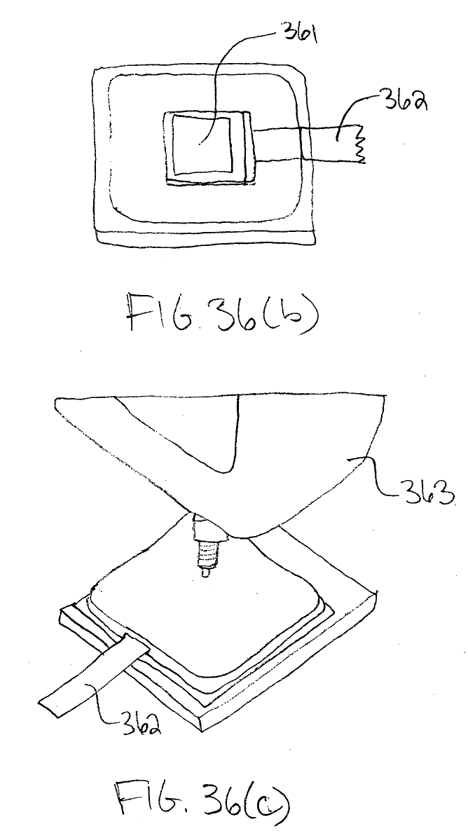

In another embodiment of this invention, the energy source for ignition may be embedded within the assembly. An example is shown in FIG. 37, which schematically illustrates igniting foil 370 using an embedded firing pin 371 (e.g., projectile) configured to be accelerated at the moment of ignition using a pre-loaded mechanical spring 372 so as to ignite foil 370. A remotely-activated trigger is used for this purpose. It should be evident for anyone skilled in the art how to generalize the present invention. In particular, the embedded power source may comprise a voltage source, a current source, a charged capacitor, a piezoelectric device, a thermoelectric device, a ferroelectric device, a firing pin, a laser, a MEMS device, a hot filament, a solenoid, a gated switch, an abrasive surface, a microbubble, a fuse, a multilayer tab, and SHS powder, or a heated gas.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for simulating an initiation and properties of a self-propagating reaction in a reactive multilayer foil, the method comprising the steps of:
providing an atomic concentration evolution equation;
providing an energy evolution equation including energy source terms associated with (i) a thermal diffusion of the reactive multilayer foil, (ii) a heat of mixing of the reactive multilayer foil, and (iii) a stimulus configured to initiate a chemical transformation of the reactive multilayer foil;
discretizing the atomic concentration evolution equation and the energy evolution equation to form a discretized system of equations; and
determining the behavior of an atomic concentration and energy fields of the reactive multilayer foil by integrating the discretized system of equations using parameters associated with the reactive multilayer foil.

2. The method of claim 1, wherein the atomic concentration evolution equation is
$$\frac{ⅆ C}{ⅆ t} - ∇ \cdot ( D ∇ C ) = 0$$
wherein C is atomic concentration and D is atomic diffusivity.

3. The method of claim 1, wherein the energy evolution equation is
$$\frac{ⅆ H}{ⅆ t} = ∇ \cdot ( k ∇ T ) + \frac{ⅆ Q}{ⅆ t}$$
wherein H is enthalpy, k is thermal conductivity, t is time, T is temperature, and Q is heat of reaction.

4. The method of claim 1, wherein the energy evolution equation is
$$\frac{ⅆ H}{ⅆ t} = ∇ \cdot ( k ∇ T ) + \frac{ⅆ Q}{ⅆ t} + {q}^{′′′}$$
wherein H is enthalpy, k is thermal conductivity, t is time, T is temperature, and Q is heat of reaction, and q^{m} is rate of energy generation associated with the stimulus.

5. The method of claim 1, wherein the discretization of the atomic concentration evolution equation and the energy evolution equation is based on a finite-difference method, a finite-element method, a finite-volume method, a spectral-element method, or a collocation method.

6. The method of claim 1, wherein the parameters associated with the reactive multilayer foil include at least one of length, width, thickness, density, heat capacity, thermal conductivity, heat of fusion, melting temperature, heat of reaction, atomic weight, atomic diffusivity, and activation energy.

7. The method of claim 1, wherein the stimulus is associated with one or more of an electrical source, a thermal source, a source of mechanical action, a sound source, an ultrasound source, a microwave source, a chemical source, an RF source, and an electromagnetic source.

8. The method of claim 1, wherein the energy source term associated with the stimulus is a volumetric source term, a surface source term, or a combination of the volumetric and surface source terms.

9. The method of claim 1, further comprising varying parameters of the stimulus.

10. The method of claim 9, wherein the parameters associated with the stimulus include one or more of a position of the stimulus relative to the reactive multilayer foil, potential energy, kinetic energy, electrical potential, current voltage, pulse duration, contact area, power, wavelength, spot size, and pulse energy.

11. A program storage device readable by a machine, tangibly embodying a program of instructions executable by the machine to perform method steps for simulating an initiation and properties of a self-propagating reaction in a reactive multilayer foil, the method comprising the steps of:
providing an atomic concentration evolution equation;
providing an energy evolution equation including energy source terms associated with (i) a thermal diffusion of the reactive multilayer foil, (ii) a heat of mixing of the reactive multilayer foil, and (iii) a stimulus configured to initiate a chemical transformation of the reactive multilayer foil;
discretizing the atomic concentration evolution equation and the energy evolution equation to form a discretized system of equations;
determining the behavior of an atomic concentration and energy fields of the reactive multilayer foil by integrating the discretized system of equations using parameters associated with the reactive multilayer foil.

12. The method of claim 11, wherein the atomic concentration evolution equation is
$$\frac{ⅆ C}{ⅆ t} - ∇ \cdot ( D ∇ C ) = 0$$
wherein C is atomic concentration and D is atomic diffusivity.

13. The method of claim 11, wherein the energy evolution equation is
$$\frac{ⅆ H}{ⅆ t} = ∇ \cdot ( k ∇ T ) + \frac{ⅆ Q}{ⅆ t}$$
wherein H is enthalpy, k is thermal conductivity, t is time, T is temperature, and Q is heat of reaction.

14. The method of claim 11, wherein the energy evolution equation is
$$\frac{ⅆ H}{ⅆ t} = ∇ \cdot ( k ∇ T ) + \frac{ⅆ Q}{ⅆ t} + {q}^{m}$$
wherein H is enthalpy, k is thermal conductivity, t is time, T is temperature, and Q is heat of reaction, and q^{m} is rate of energy generation associated with the stimulus.

15. The method of claim 11, wherein the discretization of the atomic concentration evolution equation and the energy evolution equation is based on a finite-difference method, a finite-element method, a finite-volume method, a spectral-element method, or a collocation method.

16. The method of claim 11, wherein the parameters associated with the reactive multilayer foil include at least one of length, width, thickness, density, heat capacity, thermal conductivity, heat of fusion, melting temperature, heat of reaction, atomic weight, atomic diffusivity, and activation energy.

17. The method of claim 11, wherein the stimulus is associated with one or more of an electrical source, a thermal source, a source of mechanical action, a sound source, an ultrasound source, a microwave source, a chemical source, an RF source, and an electromagnetic source.

18. The method of claim 11, wherein the energy source term associated with the stimulus is a volumetric source term, a surface source term, or a combination of the volumetric and surface source terms.

19. The method of claim 11, further comprising varying parameters of the stimulus.

20. The method of claim 19, wherein parameters associated with the stimulus include one or more of a position of the stimulus relative to the reactive multilayer foil, potential energy, kinetic energy, electrical potential, current voltage, pulse duration, contact area, power, wavelength, spot size, and pulse energy.

21. A method of initiating a chemical transformation of a reactive multilayer foil, comprising:
providing an electrical energy source and the reactive multilayer foil; and
initiating the chemical transformation of the reactive multilayer foil by providing an arc-free discharge from the electrical energy source to the reactive multilayer foil.

22. The method of claim 21, wherein the electrical energy source includes one or more of a voltage source, a current source, a charged capacitor, a piezoelectric device, a thermoelectric device, and a ferroelectric device.

23. The method of claim 21, wherein the electrical energy source has a potential less than or equal to about 10V.

24. The method of claim 21, wherein the electrical energy source has a potential less than or equal to about 5V.

25. The method of claim 21, wherein the electrical energy source has a potential less than or equal to about 1V.

26. The method of claim 21, wherein the arc-free discharge has a duration less than or equal to about 1 ms.

27. The method of claim 21, wherein an electrical lead is operatively connected to the electrical energy source and placed in contact with the reactive multilayer material,
wherein a contact area between the electrical lead and the reactive multilayer foil has a diameter less than or equal to about 1 mm.

28. The method of claim 21, wherein the arc-free discharge is provided to the reactive multilayer material at a contact area having a diameter less than or equal to about 1 mm.

29. The method of claim 21, wherein the arc-free discharge has an energy less than or equal to about 40 mJ.

30. A method of initiating a chemical transformation of a reactive multilayer foil, comprising:
providing a laser source and the reactive multilayer foil; and
initiating the chemical transformation of the reactive multilayer foil by transferring energy from the laser source to the reactive multilayer material;
wherein the energy from the laser source impinges on a spot on the reactive multilayer foil having a diameter less than or equal to about 1 mm.

31. A method of initiating a chemical transformation of a reactive multilayer foil, comprising:
providing a laser source and the reactive multilayer foil; and
initiating the chemical transformation of the reactive multilayer foil by transferring energy from the laser source to the reactive multilayer material;
wherein the laser source has a power output less than or equal to about 300 W.

32. A method of initiating a chemical transformation of a reactive multilayer foil, comprising:
providing a laser source and the reactive multilayer foil; and
initiating the chemical transformation of the reactive multilayer foil by transferring energy from the laser source to the reactive multilayer material;
wherein the energy transferred is less than or equal to about 40 mJ.

33. The method of claim 30, wherein the energy is transferred at a wavelength between about 300 nm and about 2 microns.

34. The method of claim 31, wherein the energy is transferred at a wavelength between about 300 nm and about 2 microns.

35. The method of claim 32, wherein the energy is transferred at a wavelength between about 300 nm and about 2 microns.

36. A method of initiating a chemical transformation of a reactive multilayer foil, comprising:
providing a laser source and the reactive multilayer foil; and
initiating the chemical transformation of the reactive multilayer foil by transferring energy from the laser source to the reactive multilayer material;
wherein the reactive multilayer foil includes at least one layer of solder or braze.

37. The method of claim 36, wherein the at least one layer of solder or braze includes one or more of indium, lead, tin, silver, zinc, gold, and antimony.

38. A method of initiating a chemical transformation of a reactive multilayer foil, comprising:
providing a laser source and the reactive multilayer foil;
providing a component to be joined to another component by the chemical transformation of the reactive multilayer foil, the component including an optical path configured to allow the energy from the laser source to be transferred to the reactive multilayer foil via the optical path; and
initiating the chemical transformation of the reactive multilayer foil by transferring energy from the laser source to the reactive multilayer foil through the optical path.

39. A method of initiating a chemical transformation of a reactive multilayer foil, comprising:
providing a laser source and the reactive multilayer foil; and
initiating the chemical transformation of the reactive multilayer foil by transferring energy from the laser source to the reactive multilayer material;
wherein the energy from the laser source is redirected prior to being transferred to the reactive multilayer foil.

40. The method of claim 39, further comprising providing an optical system and redirecting the energy via the optical system.

41. A method of initiating a chemical transformation of a reactive multilayer foil, comprising:
providing a laser source, a fiber optic cable, and the reactive multilayer foil; and
initiating the chemical transformation of the reactive multilayer foil by transferring energy from the laser source via the fiber optic cable to the reactive multilayer material.

42. A method of initiating a chemical transformation of a reactive multilayer foil, comprising:
providing a laser source and the reactive multilayer foil, the reactive multilayer foil being partially coated with an energy absorbing material; and
initiating the chemical transformation of the reactive multilayer foil by transferring energy from the laser source to the energy absorbing material.

43. The method of claim 42, wherein the reactive multilayer foil is partially coated with an energy reflecting material.

44. The method of claim 43, wherein the energy reflecting material has a higher reflectivity than the reactive multilayer foil.

45. The method of claim 42, wherein the energy absorbing material includes carbon black or black ink.

46. The method of claim 42, wherein the energy absorbing material has a higher absorptivity than the reactive multilayer foil.

47. A method of initiating a chemical transformation of a reactive multilayer foil, comprising:
providing a microwave source and the reactive multilayer foil; and
initiating the chemical transformation of the reactive multilayer foil by transferring energy from the microwave source to the reactive multilayer foil.

48. A method of initiating a chemical transformation of a reactive multilayer foil, comprising:
providing the reactive multilayer foil and a projectile; and
penetrating the reactive multilayer foil with the projectile,
wherein the penetrating initiates the chemical transformation of the reactive multilayer material.

49. The method of claim 48, wherein the projectile is spring-loaded.

50. A method of initiating a chemical transformation of a reactive multilayer foil, comprising:
providing an ultrasound source and the reactive multilayer foil; and
initiating the chemical transformation of the reactive multilayer foil by-transferring energy from the ultrasound source to the reactive multilayer foil.

51. A method of initiating a chemical transformation of a reactive multilayer foil, comprising:
providing an induction heating source and the reactive multilayer foil; and
initiating the chemical transformation of the reactive multilayer foil by transferring energy from the induction heating source to the reactive multilayer foil.

52. The method of claim 51, wherein the reactive multilayer foil includes a magnetic element.

53. The method of claim 52, wherein the magnetic element is Ni.

54. A method of initiating a chemical transformation of a reactive multilayer foil, comprising:
providing the reactive multilayer foil; and
initiating the chemical transformation of the reactive multilayer foil by mechanically fracturing the reactive multilayer foil.

55. The method of claim 54, wherein the reactive multilayer foil includes a recessed portion,
wherein the recessed portion is configured to assist in the mechanical fracturing of the reactive multilayer foil.

56. The method of claim 55, wherein the reactive multilayer foil is configured to mechanically fracture at the recessed portion.

57. A method of initiating a chemical transformation of a reactive multilayer foil, comprising:
providing the reactive multilayer foil; and
initiating the chemical transformation of a reactive multilayer foil by generating friction on the reactive multilayer foil.

58. The method of claim 57, further comprising providing an object with an abrasive surface,
wherein generating friction includes placing the abrasive surface in contact with the reactive multilayer foil.

59. The method of claim 58, wherein generating friction includes rotating the object.

60. The method of claim 57, wherein generating friction includes sliding the object.

61. The method of claim 58, wherein the object includes a rotary tool bit.

62. The method of claim 58, wherein the object includes a diamond wheel.

63. A method of initiating a chemical transformation of a reactive multilayer foil, comprising:
providing an electrical energy source, the reactive multilayer foil, and an electrical lead; and
initiating the chemical transformation of the reactive multilayer foil by transferring energy from the electrical energy source to the reactive multilayer foil via the electrical lead.

64. The method of claim 63, further comprising providing a component to be joined to another component by the chemical transformation of the reactive multilayer foil,
wherein the component includes the electrical lead.

65. The method of claim 63, wherein the electrical energy source includes one or more of a voltage source, a current source, a charged capacitor, a piezoelectric device, a thermoelectric device, and a ferroelectric device.

66. A method of initiating a chemical transformation of a reactive multilayer material, comprising:
providing the reactive multilayer material and a component including an ignition source; and
initiating the chemical transformation of the reactive multilayer material by triggering the ignition source.

67. The method of claim 66, wherein triggering the ignition source includes remotely triggering the ignition source.

68. The method of claim 66, wherein the ignition source includes one or more of a voltage source, a current source, a charged capacitor, a piezoelectric device, a thermoelectric device, a ferroelectric device, a firing pin, a laser, a MEMS device, a hot filament, a solenoid, a gated switch, an abrasive surface, a microbubble, a fuse, a reactive multilayer tab, a chemical, an SHS powder, and a heated gas.

69. A method of initiating a chemical transformation of a reactive multilayer foil, comprising:
providing a chemical and the reactive multilayer foil; and
initiating a chemical transformation of a reactive multilayer foil by chemically transforming the chemical.

70. A method of initiating a chemical transformation of a reactive multilayer foil, comprising:
providing the reactive multilayer foil; and
heating the reactive multilayer foil to the foil's ignition temperature.

71. The method of claim 70, further comprising providing a heating source;
placing the reactive multilayer foil in the source of heat,
wherein the heating includes heating the reactive multilayer foil in the heating source.

72. The method of claim 71, wherein the heating source is a furnace or reflow oven.

73. The method of claim 70, wherein the heating occurs at a rate greater than or equal to about 200° C./min.

74. The method of claim 70, wherein the heating includes heating one side of the reactive multilayer foil.

75. The method of claim 70, wherein the reactive multilayer foil is disposed in an enclosure or assembly,
wherein the heating includes heating one side of the enclosure or assembly.

76. The method of claim 70, wherein the reactive multilayer foil is disposed between two or more components configured to be joined by the chemical transformation of the reactive multilayer foil,
wherein the heating includes heating one of the two or more components.

77. The method of claim 76, wherein the heating of one of the two or more components includes passing a current through the one of the two or more components.

78. A method of initiating a chemical transformation of a reactive multilayer foil, comprising:
providing the reactive multilayer foil and a molten material; and
initiating the chemical transformation of the reactive multilayer foil by transferring energy from the molten material to the reactive multilayer foil.

79. The method of claim 78, further comprising placing the molten material in contact with the reactive multilayer foil.

80. The method of claim 78, wherein the molten material is molten solder or molten braze.

81. A method of initiating a chemical transformation of a reactive multilayer foil, comprising:
providing the reactive multilayer foil and a microflame; and
initiating the chemical transformation of the reactive multilayer foil by transferring energy from the microflame to the reactive multilayer foil.

82. The method of claim 81, further comprising placing the microflame in contact with the reactive multilayer foil.

83. The method of claim 81, wherein the reactive multilayer foil is disposed between at least two components,
wherein a portion of the reactive multilayer foil extends past an edge of at least one of the at least two components,
the method further comprising directing the microflame towards the portion of the reactive multilayer foil.

84. A method of initiating a chemical transformation of a reactive multilayer foil, comprising:
providing the reactive multilayer foil, the reactive multilayer foil being surrounded by an enclosure or disposed within an assembly;
providing an energy source; and
initiating the chemical transformation of the reactive multilayer foil by transferring energy from the energy source to the reactive multilayer foil.

85. The method of claim 84, wherein the energy is transferred without penetrating the enclosure or assembly.

86. The method of claim 84, wherein the energy is transferred to the reactive multilayer foil when the energy source is disposed outside of the enclosure or assembly.

87. The method of claim 84, wherein the energy is transferred without placing the source of energy in physical contact with the reactive multilayer foil.

88. The method of claim 84, wherein the enclosure is substantially airtight.

89. The method of claim 84, wherein the energy source includes one or more of a microwave source, an ultrasound source, and a source of induction heating.
